(19) United States
(12) Patent Application Publication
(10) Pub. No.: US 2010/0071830 A1
(43) Pub. Date: Mar. 25, 2010

(54) METHOD OF LABELING BOTTLES AND CONTAINERS IN A BOTTLE OR CONTAINER FILLING PLANT, AND A BOTTLE OR CONTAINER LABELING ARRANGEMENT THEREFOR

(76) Inventor: Frank PUTZER, Hamburg (DE)

Correspondence Address: NILS H. LJUNGMAN & ASSOCIATES, P. O. BOX 130, GREENSBURG, PA, 15601-0130, US

(21) Appl. No.: 12/380,895

(22) Filed: Mar. 2, 2009

Related U.S. Application Data
(63) Continuation-in-part of application No. PCT/EP2007/004668, filed on May 25, 2007.

(30) Foreign Application Priority Data
Sep. 2, 2006 (DE) 10 2006 026 618.8

(51) Int. Cl. B29C 65/48; B29C 65/80; G05G 15/00

(52) U.S. Cl. 156/64; 156/351

(57) ABSTRACT

A method of labeling bottles and containers in a bottle or container filling plant, and a bottle or container labeling arrangement therefor. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP2007/004668, filed on May 25, 2007, which claims priority from Federal Republic of Germany Patent Application No. 10 2006 026 618.8, filed on Sep. 2, 2006. International Patent Application No. PCT/EP2007/004668 was pending as of the filing date of this application. The United States was an elected state in International Patent Application No. PCT/EP2007/004668.

### BACKGROUND

1. Technical Field

The present application relates to a method of labeling bottles and containers in a bottle or container filling plant, and a bottle or container labeling arrangement therefor.

2. Background Information

Background information is for informational purposes only and does not necessarily admit that subsequently mentioned information and publications are prior art.

Some methods for labeling bottles include bottles or similar containers that have container-typical design features, for example typical geometrical features on their outside surfaces, such as seal surfaces, ornaments, embossments, raised printing, etc. When labeling such containers, it is necessary and/or desired to apply the respective labels very accurately with respect to such container-typical design features and within the tightest possible tolerances, for example in a range of +/− one-half of a millimeter, even at the high throughputs typical of labeling machines today, which can be as high as 60,000 labeled containers per hour, for example.

In some methods, the containers, which are fed in a random orientation with respect to their typical design features to the container carriers of a powered rotor of a labeling machine revolving around a vertical machine axis, are aligned by the controlled turning of the container carriers prior to labeling so that the labels can be applied to the aligned containers as the containers pass a labeling station. Alignment of the containers by turning the container carriers can be performed by means of control signals from an image detection and processing system, which includes, among other things, a camera system comprising at least one electronic camera and suitable lighting, a computer and image processing and image detection software.

Using the camera system, distinctive areas or reference areas or edges of the respective container-typical design feature are detected, and the container carriers are then rotated by an angle of rotation calculated on the basis of an image comparison, i.e. a comparison of expected and actual values to calculate said angle of rotation. Container-typical design features include, for example, the form of the respective container and/or the container-typical geometric features on the outside surface of the container, such as a seal surface, ornament, embossment, raised lettering, etc.

The number of cameras required and/or desired for the camera system is a function of the properties of the containers to be processed (e.g. material, transparency or opacity, color, surface or surface texture, filling, etc.).

Whereas this procedure does enable an alignment of the containers according to their design features prior to subsequent labeling, the label positioning accuracy in relation to the container-typical features possible in this manner is very limited, so that the achievable accuracy often no longer satisfies today's requirements. For example, when applying labels concentrically, e.g. within a seal mark or surface, even the smallest deviations are visually readily apparent and perceived as extremely disadvantageous.

There are numerous reasons for such deviations, including but not limited to: tolerances within the containers, which are due to the manufacturing processes for the containers, for example; the container to be labeled does not fully follow the rotary motion of the container carrier due to slip between the container carrier and the container, for example due to fouling and/or moisture on the container and/or container carrier, resulting in deviations from the specified position during alignment.

The latter is problematic because generally a relatively small angle of rotation of the rotor and thus with high throughputs a very short period of time is available for alignment, so that alignment must or should be performed with relatively high rotational or angular accelerations.

### OBJECT OR OBJECTS

An object of the present application is to describe a method that avoids, restricts, and/or minimizes the aforementioned disadvantages and permits or promotes the highly positionally accurate placement of labels on bottles, cans or similar containers in relation to typical geometric container features on the outside surface of the containers.

### SUMMARY

The present application relates to a method of labeling bottles and containers in a bottle or container filling plant, and a bottle or container labeling arrangement therefor. The present application further relates to a method for the application of labels to bottles or similar containers in relation to at least one container-typical design feature using at least one image detection and processing system having at least one camera, with which the container-typical design feature of each container moved past this camera on a transport element is detected and which supplies a signal controlling the labeling process, and a labeling machine for the positionally accurate application of labels to bottles, cans or similar containers in relation to at least on container-typical design feature having at least one image detection and processing system with at least one camera, with which the container-typical design feature of each container moved past this camera on a transport element is detected and which supplies a signal controlling the labeling process, and also having at least one labeling station arranged along the path of motion of the transport element performing this method.

A method for achieving this object is disclosed as a method for the positionally accurate application of labels to bottles, cans, or similar containers in relation to at least on container-typical design feature using at least one image detection and processing system having at least one camera. The container-typical design feature of each container is moved past this camera on a transport element, is detected, and the camera sends a signal controlling the labeling process. The image detection and processing system detects the orientation and/or the actual form of the container-typical design feature of each container and uses this to control the instant of transfer of the label to the respective container such that following application the label is optimally positioned there in relation to the container-typical design feature. An apparatus or labeling machine for performing the method is disclosed as a labeling machine for the positionally accurate application of labels to bottles, cans, or similar containers in relation to at least on container-typical design feature having at least one image detection and processing system with at least one camera. The container-typical design feature of each container is moved past this camera on a transport element and is detected, and the camera supplies a signal controlling the labeling process. The labeling machine also comprises at least one labeling station arranged along the path of motion of the transport element. The image detection and processing system detects the orientation and/or the actual form of the container-typical design feature of each container and generates from this a signal controlling the instant of transfer of the respective label at the labeling station.

In one possible embodiment of the method according to the present application, the start or transfer instant or moment of transfer at which the respective label is applied to the containers moving past the labeling station is controlled as a function of the orientation and/or actual form, i.e. as a function of the size and/or shape of the respective container-typical design features, by driving the labeling station accordingly and without any alignment or rotation of the containers.

Bottles or containers of assorted sizes and shapes may be used with this method of labeling. Some bottles may comprise a variety of shapes, for example hour-glass shapes like twelve-ounce V8™ vegetable juice and V8 V-Fusion® juice bottles. Some containers are shaped like human bodies, like Mrs. Butterworth's® bottles, or animal bodies, like Mimi's Bees eight-ounce squeeze bear bottle or Mimi's Bees sixteen-ounce bee bottle. Some bottles or containers are shaped like objects, such as guns, like a two hundred milliliter Hijos de Villa Reposado Pistol Tequila bottle, buildings, like a Rubyat perfume bottle, or fruit, like a Jif real lemon juice bottle. In addition, containers used with this method may have a variety of features to be detected, such as ridges, like a Poland Spring water bottle, raised letters or numbers, like a Rolling Rock® beer bottle, frames or borders, such as a Sigg Frames Lime 1 Liter/33 Ounce Aluminum Water Bottle, bumps or raised areas, like a football-shaped Dr Pepper® bottle, and geometric shapes, such as the rectangular indents on a sixty-four-ounce Gatorade bottle. Also, the bottles which can be used with the method of the present application can have any combination of the above mentioned shapes, sizes, and features, among many others.

The control of the start or transfer instant or moment of transfer is controlled by means of an image detection and processing system, which detects the container-typical design features of each container and analyzes or processes the respective image to control the start or transfer instant or to control the labeling station so that the label is then transferred and applied to the respective container highly accurately in relation to its container-typical design features.

The above-discussed embodiments of the present invention will be described further herein below. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

Further embodiments are disclosed according to the present application. One possible embodiment of the present application is described in greater detail below illustrated with the accompanying drawings, in which:

FIG. 1 shows a simplified side view of a container in the form of a bottle having a typical geometric feature on the outside surface, namely having a seal surface;

FIG. 2 shows a simplified plan view of a rotary labeling machine for the labeling of bottles in the area of their outer surface bearing the typical geometrical feature;

FIG. 2A shows another simplified plan view of a rotary labeling machine for the labeling of bottles in the area of their outer surface bearing the typical geometrical feature; and

FIG. 3 shows schematically the main components of one possible embodiment example of a system for filling containers, specifically, a beverage bottling plant for filling bottles with at least one liquid beverage, in accordance with at least one possible embodiment, in which system or plant could possibly be utilized at least one aspect, or several aspects, of the embodiments disclosed herein.

### DESCRIPTION OF EMBODIMENT OR EMBODIMENTS

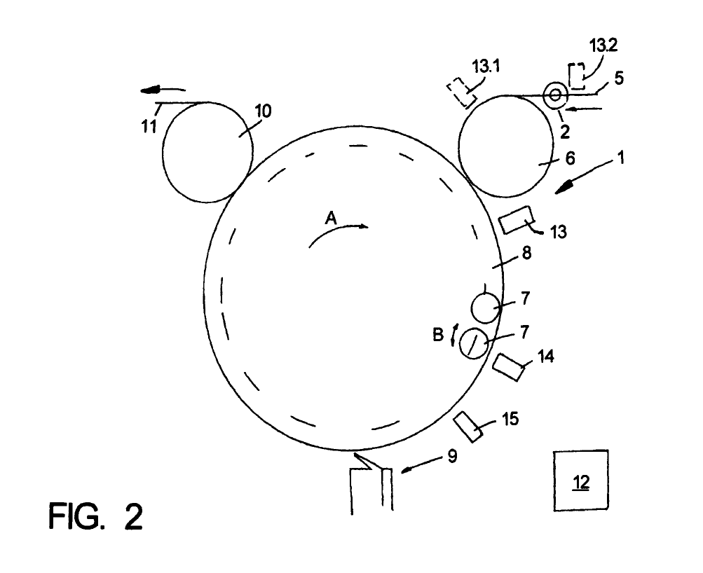

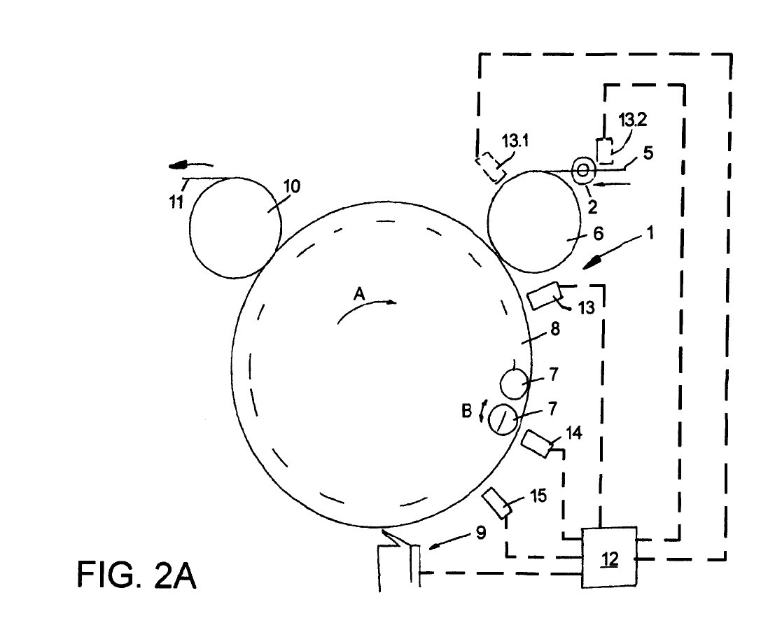

The rotary labeling machine generally designated 1 in FIG. 2 is used to label bottles 2, i.e. to apply labels 3 to the circumferential surface of the bottles 2 as accurately as possible, or at least at or above a predetermined minimum level of accuracy, in relation to a typical or distinctive feature 4 located on the outer surface of the bottle 2. In the embodiment shown here, this geometric feature 4 is a seal surface, with the respective label 3 to be located exactly or generally in the center of said surface.

The geometric feature 4 in relation to which the labels 3 are to be applied with the highest of positional accuracy can also be realized differently, i.e. in the form of an ornament, an embossment, raised printing on the outside surface, etc.

The bottles 2 to be labeled stand upright, i.e. with their bottle or container axis oriented in the vertical direction, as they are transported as a single stream of bottles via a conveyor 5 to the labeling machine 1, where a starwheel 6 serving as a bottle or container inlet places one bottle each onto a bottle or container carrier 7 that is provided together with a plurality of identical container carriers 7 on the circumference of a powered rotor 8 rotating (arrow A) around a vertical machine axis.

Each bottle 2 on its container carrier 7 is precisely or generally aligned in relation to the geometric feature 4 by rotating the container carrier around a vertical container axis (double arrows B in FIG. 2) and thus moved with the rotating rotor 8 past a labeling station 9, at which the respective label 3 is transferred by the leading edge 3.1 of the label to the bottle moving past the labeling station 9 in such a manner that the respective label 3 is very precisely or generally positioned in relation to the geometric feature 4 after the label has been completely pressed onto the bottle 2, i.e. the respective label 3 is located in the center of the geometric feature 4 and is either raised or surrounded by a bead-like edge. In the embodiment shown here, the labeling station 9 is configured for the processing of self-adhesive labels 3. The present application also allows the use of other labeling stations or systems, for example for the application of labels 3 using glue.

The labeled bottles 2 are moved by the rotor 8 via a bottle or container outlet in the form of a starwheel 10 onto a conveyor 11, which transports them for further processing, e.g. to a packing machine. The container carriers 7 are, for example, bottle plates, on which the bottles 2 stand on their bases. Other embodiments of bottle carriers 7 are plausible, for example in a form in which the bottles 2 are held suspended from these bottle carriers 7.

To align or substantially align the bottles 2, which are transported by the conveyor 5 in a random orientation in relation to their geometric features 4, each of the individual container carriers 7 is provided with an individually controlled positioning or rotary drive to produce the controlled rotation around the vertical transport element axis as indicated by the double arrow or double-headed arrow B. The individual drives of the container carriers 7 are controlled by a central controller 12 (central computer) as a function of the signals from three camera systems, each of which are suggested schematically by the video cameras 13, 14, and 15.

The cameras 13 through 15 are each arranged between the starwheel 6 and the labeling station 9 along the path of motion of the bottles 2 on the container carriers 7 and close to the circumference of the rotor 8, but are not moved together with the rotor 8. Furthermore, the cameras 13 through 15 are oriented so that they reliably detect that region of each passing bottle 2 that bears the typical geometric feature 4. In addition, the cameras 13 through 15 are components of an image processing and detection system comprising, among other things, the respective camera 13 through 15, a corresponding light source, a computer that is the central controller or the central computer 12, for example, and image processing and detection software installed on this computer.

Each bottle 2 transferred to one of the container carriers 7 by the starwheel 6 first passes camera 13. This camera or the image detection and processing system that includes this camera 13 determines the specified position of the typical geometric feature 4 of the passing bottle 2, and then triggers a control signal from the controller 12 for controlling the respective container carrier so that the respective bottle 2 in one possible embodiment is brought into the specified position or specified orientation or general position or general orientation by means of the shortest possible rotation and as accurately as possible. The bottles 2 that have been at least prealigned in relation to their typical geometrical features 4, i.e. oriented radially outward in relation to the vertical rotor or machine axis, then pass the camera 14, with which the actual orientation of the typical geometrical feature 4 is again detected so that an additional alignment (fine alignment) of each bottle 2 can be performed by rotating the respective container carrier 7, i.e. by controlled activation of the respective positioning drive. The aperture angle of the optics of the camera 14 is in one possible embodiment selected so that contrary to camera 13, this camera does not detect the entire bottle 2 or a majority of the outside surface of the bottle 2, but essentially the typical geometric feature 4 of each bottle in the area of a distinctive element used for alignment, for example the leading edge 4.1 of the geometric feature 4 relative to the direction of rotation A of the rotor 8. The image detection and processing system that includes the camera 14 likewise determines the position of the geometric feature of each bottle 2; the feature itself and any tolerances relative to the form of this feature, such as tolerances with respect to shape and/or size, are not taken into consideration by the image detection and processing systems that include the cameras 13 and 14.

Camera 15 detects not only the orientation of the typical geometric feature 4 of each passing bottle, but also the actual form, i.e. the shape and/or size of this feature, for example. The image produced by this camera is used by the image detection and processing system that includes the camera 15 to analyze or measure this actual form of the respective feature 4 and by comparison with values (actual values) stored in the system, i.e. in the controller 12, to control the instance of transfer of the respective label at the labeling station 9 to the respective passing bottle 2 such that following application and despite tolerances for the respective geometric feature 4, e.g. with respect to shape and/or size and despite non-optimal alignment, the label is optically positioned as accurately as possible in relation to the feature 4, i.e. is applied exactly or generally in the center of this geometric feature 4 in the form of a seal face. The container carrier 7 is not rotated to control the instant of transfer of the respective label 3. However, it is understood that the instant of transfer or the starting time for the transfer of the respective label 3 to a bottle is also determined with consideration of the current rotational speed of the rotor 8.

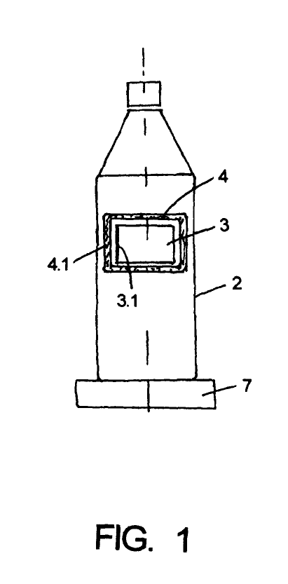

In one possible embodiment of the present application, the camera 15 analyzes the typical geometric feature 4 of each passing bottle 2. The geometric feature 4 is a raised rectangular border or frame 4, into which the label 3 is to be adhered, as seen in FIG. 1. The camera 15 measures the typical geometric feature 4 of a bottle 2, and sends this information to the central controller or central computer 12. The central computer 12 then determines the instant of transfer, the starting time for the transfer, or the moment of transfer, i.e. the moment that the leading edge 3.1 of the label 3 first comes in contact with the bottle 2 in a predetermined area of the bottle 2. In this embodiment, the labeling station 9 attaches the leading edge of the label 3.1 immediately after the leading edge 4.1 of the geometric feature 4 in the direction of rotation A. This process aligns the leading edge 3.1 of the label 3 with the leading edge 4.1 of the typical geometric feature 4.

In a further embodiment, which is similar to that described in the preceding paragraph, the labels 3 are configured to be longer than the area inside the raised rectangular border or frame 4. The central computer 12 then determines the instant of transfer, the starting time for the transfer, or the moment of transfer, i.e. the moment that the leading edge 3.1 of a label 3 first comes in contact with the bottle 2 in a predetermined area of the bottles 2. The labeling station 9 attaches leading edge of the label 3.1 after the leading edge 4.1 of the geometric feature 4 in the direction of rotation A. The labeling station 9 comprises means to cut each label 3 to a length that corresponds to the measurements of the typical geometric feature 4 of each bottle 2 made by the camera 15. In this embodiment, the transfer of the label 3 to the bottle 2 begins after the leading edge 4.1 of the raised rectangular border or frame 4, and the labels 3 are cut to the appropriate length so that the trailing ends of the labels 3 end before the trailing edge of the raised rectangular border or frame 4. In other words, the length of the label 3 stretches from one edge of the typical geometric feature 4 to the other, opposite edge of the typical geometric feature 4. In such an embodiment, the labels 3 could be self-adhesive labels.

In one possible embodiment of the present application, the camera 15 analyzes the typical geometric feature 4 of each passing bottle 2. The geometric feature 4 is a raised rectangular border or frame 4, into which the label 3 is to be adhered. The camera 15 measures the typical geometric feature 4 of a bottle 2, and sends this information to the central controller or central computer 12. The central computer 12 then determines the instant of transfer, the starting time for the transfer, or the moment of transfer, i.e. the moment that the leading edge 3.1 of the label 3 first comes in contact with the bottle 2 in a predetermined area of the bottle 2. In this embodiment, the central computer 12 determines when to begin attaching a label 3 to a bottle 2 so that the label 3 will be centered in the raised rectangular border or frame 4.

In yet another possible embodiment of the present application, the camera 15 analyzes the typical geometric feature 4 of each passing bottle 2. The geometric feature 4 is a raised rectangular border or frame 4, into which the label 3 is to be adhered. The camera 15 measures the typical geometric feature 4 of a bottle 2, and sends this information to the central controller or central computer 12. The central controller 12 can either be configured with one general image which is stretched and/or expanded and/or shrunk and/or compressed in order to comprise the dimensions of a raised frame or border 4, or the controller 12 can be configured to store many images, each of which comprise different, possible dimensions to fit in the raised border or frame 4. The central controller 12 generates an image of the label 3 which corresponds to the dimensions and/or measurements of the typical geometric feature 4 taken by the camera 15. The image of the label 3 is printed onto a label 3, which is then attached to the bottle 2 in the raised rectangular border or frame 4 by the labeling station or labeling system or labeling machine 9. In another possible embodiment, the image is printed directly onto the surface of the bottle within the raised border or frame 4.

In at least one possible embodiment of the present application, the camera 15 detects the measurements and/or dimensions of the typical geometric feature 4 of the bottle 2 in order and sends this information to the central controller and/or central computer 12, and the computer 12 then determines when to begin the transfer of the label 3 to the bottle 2 in order to promote optimal alignment of the label 3 with respect to the typical geometric feature 4. It may be possible to alter the dimensions of the label 3, so that the label 3 comprises dimensions which promote optimal alignment of the label 3 with respect to the typical geometric feature 4.

Further, it may be possible to alter the horizontal length of the label 3 as well as the vertical height of the label 3 in order to promote optimal alignment or centering of the label 3. The camera 15 measures the dimensions of the border or frame 4 and calculates the height of the inner dimensions of the frame 4. The label image could be stretched and/or compressed by the computer 12 and applied to the bottle 2, or a preprinted label 3 could be cut to the appropriate dimensions by the labeling station and/or machine and/or system 9 before the moment of transfer. Additionally, the labeling station and/or system and/or machine 9 can be configured to apply labels horizontally or vertically.

In at least one possible embodiment, the labels are dispensed intermittently or at different intervals depending on the detected position of the bottle and the typical geometric feature 4 disposed thereon. The labels therefore may be dispensed at approximately the same intervals of time, but may also be dispensed at varying intervals of time.

The present application was described above with reference to one possible embodiment. It is understood that modifications and derivations are possible. For example, it is possible to arrange the camera 13 in the area of the container or bottle inlet of the labeling machine 1, as is suggested with 13.1 and 13.2 in FIG. 2, for example at a position of the conveyor 5 in the direction of transport upstream of the inlet starwheel 6 (camera 13.1) if suitable measures, such as clamps or clamping fingers essentially ensure or promote that the bottles 2 can no longer rotate randomly around their vertical bottle axes after passing the camera 13.1. Analogously, the camera 13 can also be arranged in the area of the inlet starwheel 6, as is suggested with 13.2, if suitable measures such as clamping fingers, etc. are taken at least at inlet starwheel 6 to prevent, restrict, and/or minimize random rotation of the bottles 2 around their vertical bottle axes.

FIG. 2A shows another possible embodiment of the present application. The cameras 13.1, 13.2, 13, 14, and 15 are operatively connected with the central computer or central connector 12, which allows the cameras 13.1, 13.2, 13, 14, and 15 to send signals to the computer 12. These signals allow the computer 12 to determine the orientation of the bottles 2 and the size and shape of the typical geometric feature 4 of the bottles 2. The signals also allow the computer 12 to calculate which way to rotate the bottles 2 in the container carriers 7 and to what degree to rotate the bottles 2 in the container carriers 7. Additionally, the computer 12 is configured to determine and/or calculate the moment of transfer and/or the position of transfer of the label 3 to the bottle 2 as the rotor 8 moves the bottles 2 past the labeling station and/or labeling machine and/or labeling system 9. The computer 12 is operatively connected to the labeling device 9 and is further configured to send signals to the labeling device 9 to initiate labeling at the moment of transfer to promote optimum alignment of the label 3 with the geometric feature 4.

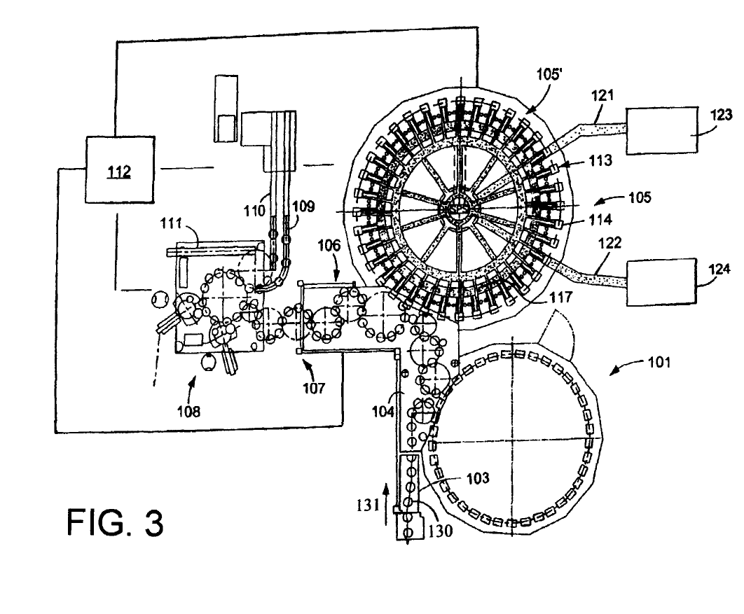

FIG. 3 shows schematically the main components of one possible embodiment example of a system for filling containers, specifically, a beverage bottling plant for filling bottles 130 with at least one liquid beverage, in accordance with at least one possible embodiment, in which system or plant could possibly be utilized at least one aspect, or several aspects, of the embodiments disclosed herein.

FIG. 3 shows a rinsing arrangement or rinsing station 101, to which the containers, namely bottles 130, are fed in the direction of travel as indicated by the arrow 131, by a first conveyer arrangement 103, which can be a linear conveyor or a combination of a linear conveyor and a starwheel. Downstream of the rinsing arrangement or rinsing station 101, in the direction of travel as indicated by the arrow 131, the rinsed bottles 130 are transported to a beverage filling machine 105 by a second conveyer arrangement 104 that is formed, for example, by one or more starwheels that introduce bottles 130 into the beverage filling machine 105.

The beverage filling machine 105 shown is of a revolving or rotary design, with a rotor 105′, which revolves around a central, vertical machine axis. The rotor 105′ is designed to receive and hold the bottles 130 for filling at a plurality of filling positions 113 located about the periphery of the rotor 105′. At each of the filling positions 103 is located a filling arrangement 114 having at least one filling device, element, apparatus, or valve. The filling arrangements 114 are designed to introduce a predetermined volume or amount of liquid beverage into the interior of the bottles 130 to a predetermined or desired level.

The filling arrangements 114 receive the liquid beverage material from a toroidal or annular vessel 117, in which a supply of liquid beverage material is stored under pressure by a gas. The toroidal vessel 117 is a component, for example, of the revolving rotor 105′. The toroidal vessel 117 can be connected by means of a rotary coupling or a coupling that permits rotation. The toroidal vessel 117 is also connected to at least one external reservoir or supply of liquid beverage material by a conduit or supply line. In the embodiment shown in FIG. 3, there are two external supply reservoirs 123 and 124, each of which is configured to store either the same liquid beverage product or different products. These reservoirs 123, 124 are connected to the toroidal or annular vessel 117 by corresponding supply lines, conduits, or arrangements 121 and 122. The external supply reservoirs 123, 124 could be in the form of simple storage tanks, or in the form of liquid beverage product mixers, in at least one possible embodiment.

As well as the more typical filling machines having one toroidal vessel, it is possible that in at least one possible embodiment there could be a second toroidal or annular vessel which contains a second product. In this case, each filling arrangement 114 could be connected by separate connections to each of the two toroidal vessels and have two individually-controllable fluid or control valves, so that in each bottle 130, the first product or the second product can be filled by means of an appropriate control of the filling product or fluid valves.

Downstream of the beverage filling machine 105, in the direction of travel of the bottles 130, there can be a beverage bottle closing arrangement or closing station 106 which closes or caps the bottles 130. The beverage bottle closing arrangement or closing station 106 can be connected by a third conveyer arrangement 107 to a beverage bottle labeling arrangement or labeling station 108. The third conveyor arrangement may be formed, for example, by a plurality of starwheels, or may also include a linear conveyor device.

In the illustrated embodiment, the beverage bottle labeling arrangement or labeling station 108 has at least one labeling unit, device, or module, for applying labels to bottles 130. In the embodiment shown, the labeling arrangement 108 is connected by a starwheel conveyer structure to three output conveyer arrangements: a first output conveyer arrangement 109, a second output conveyer arrangement 110, and a third output conveyer arrangement 111, all of which convey filled, closed, and labeled bottles 130 to different locations.

The first output conveyer arrangement 109, in the embodiment shown, is designed to convey bottles 130 that are filled with a first type of liquid beverage supplied by, for example, the supply reservoir 123. The second output conveyer arrangement 110, in the embodiment shown, is designed to convey bottles 130 that are filled with a second type of liquid beverage supplied by, for example, the supply reservoir 124. The third output conveyer arrangement 111, in the embodiment shown, is designed to convey incorrectly labeled bottles 130. To further explain, the labeling arrangement 108 can comprise at least one beverage bottle inspection or monitoring device that inspects or monitors the location of labels on the bottles 130 to determine if the labels have been correctly placed or aligned on the bottles 130. The third output conveyer arrangement 111 removes any bottles 130 which have been incorrectly labeled as determined by the inspecting device.

The beverage bottling plant can be controlled by a central control arrangement 112, which could be, for example, computerized control system that monitors and controls the operation of the various stations and mechanisms of the beverage bottling plant.

Another possibility, for example when processing bottles with an easy-to-detect geometry, is to perform the fine alignment, as described above pursuant to the camera 14 and the associated image detection and processing software, and the control of the transfer instant or start time of the transfer of the label as a function of the detected actual orientation and form of the respective geometric feature 4 using a common camera, for example the camera 14. The camera 15, for example, would be eliminated in this case. The image produced by camera 14 is first used for the fine alignment and subsequently for the control of the instant of transfer of the respective label 3. In one possible embodiment of the present application, the elimination of one camera enlarges the angle of rotation between the camera used for the fine alignment and the determination of the instant of transfer of the label and the labeling station 9, increasing the time available for fine alignment. Even at high labeling machine 1 throughputs (number of bottles 2 labeled per unit time) and high rotor 8 speeds, the accelerations (rotational accelerations) when rotating or aligning the container carriers 7 can be reduced sufficiently to prevent, restrict, and/or minimize slip due to the mass inertia of the bottles 2 between the individual container carriers 7 and the bottles 2 thereon during the fine alignment.

The present application was elucidated above with reference to a labeling machine 1 for the labeling of bottles. Other containers such as cans could also be labeled in the manner described, of course.

In a method for the positionally accurate application of labels to bottles, cans or similar containers in relation to at least one container-typical design feature, the container-typical design feature of each container moved on a transport element passed at least one camera is detected using at least one image detection and processing system having said at least one camera.

One feature or aspect of an embodiment is believed at the time of the filing of this patent application to possibly reside broadly in the method for the positionally accurate application of labels 3 to bottles, cans or similar containers 2 in relation to at least one container-typical design feature 4 using at least one image detection and processing system having at least one camera 15, with which the container-typical design feature 4 of each container 2 moved past this camera on a transport element 8 is detected and which supplies a signal controlling the labeling process, wherein the image detection and processing system 4, 15 detects the orientation and/or the actual form of the container-typical design feature 4 of each container 2 and uses this to control the instant of transfer of the label 3 to the respective container 2 such that following application the label is optimally positioned there in relation to the container-typical design feature 4.

Another feature or aspect of an embodiment is believed at the time of the filing of this patent application to possibly reside broadly in the method, wherein the instant of transfer or the starting time for the transfer of the respective label 3 to a container is also controlled as a function of the speed of the transport element 8.

Yet another feature or aspect of an embodiment is believed at the time of the filing of this patent application to possibly reside broadly in the method, wherein the actual form of the respective container-typical design feature 4, e.g. the distance between at least two reference areas or reference edges of the design feature, is determined using the image detection and processing system for the control of the instant of transfer or start time.

Still another feature or aspect of an embodiment is believed at the time of the filing of this patent application to possibly reside broadly in the method, wherein the distance is determined between at least two reference areas or reference edges that follow one another in a direction of motion A in which the containers 2 are moved passed the at least one camera 15.

A further feature or aspect of an embodiment is believed at the time of the filing of this patent application to possibly reside broadly in the method, wherein the containers 2 are aligned in a specified orientation in relation to their container-typical design feature 4 prior to detection with the at least one camera 15 of the image detection and processing system used to control the instant of transfer of the label.

Another feature or aspect of an embodiment is believed at the time of the filing of this patent application to possibly reside broadly in the method, wherein the alignment of the containers 2 is performed by the controlled rotation of the containers 2 around a container axis.

Yet another feature or aspect of an embodiment is believed at the time of the filing of this patent application to possibly reside broadly in the method, wherein each container 2 is arranged on a container carrier 7, which for the purpose of alignment can be rotated around the container axis by control action by means of a drive.

Still another feature or aspect of an embodiment is believed at the time of the filing of this patent application to possibly reside broadly in the method, wherein each container 2 is aligned via the optical detection of at least one container-typical reference area, for example at least one container-typical reference edge 4.1.

A further feature or aspect of an embodiment is believed at the time of the filing of this patent application to possibly reside broadly in the method, wherein alignment is performed using an image detection and processing system having at least one camera 13,14.

Another feature or aspect of an embodiment is believed at the time of the filing of this patent application to possibly reside broadly in the method, wherein the alignment of the containers takes place in at least two chronologically successive steps, first a rough alignment of each container 2 by detection of the respective actual position or orientation of the container-typical design features, by comparing this actual position with a specified or general position or orientation and by rotating the container into the specified or general position, and then a subsequent fine alignment comprising detection of the actual position or orientation of the container-typical design feature, comparison of the actual position or orientation with a specified or general position or orientation and rotation of the container 2 into the specified for general position.

Yet another feature or aspect of an embodiment is believed at the time of the filing of this patent application to possibly reside broadly in the method, wherein rough alignment and the fine alignment are each performed using the image detection and processing system having at least one camera 13, 14.

Still another feature or aspect of an embodiment is believed at the time of the filing of this patent application to possibly reside broadly in the method, wherein a common computer 12 is used for the image detection and processing system controlling the instant of transfer and for the image detection and processing system controlling the alignment of the containers 2.

A further feature or aspect of an embodiment is believed at the time of the filing of this patent application to possibly reside broadly in the method, wherein a common camera 14 is used for the image detection and processing system controlling the instant of transfer of the labels and for the image detection and processing system controlling the alignment, e.g. the fine alignment, of the containers 2.

One feature or aspect of an embodiment is believed at the time of the filing of this patent application to possibly reside broadly in the method, wherein the labels 3 are self-adhesive labels.

Another feature or aspect of an embodiment is believed at the time of the filing of this patent application to possibly reside broadly in the method, wherein a rotary labeling machine 1 having a powered rotor 8 that rotates around a vertical machine axis and that has a plurality of container carriers 7 arranged around the circumference of the rotor, on which carriers the containers 2 are moved passed the at least one camera 13, 13.1, 13.2, 14, 15 and the at least one labeling station 9.

Yet another feature or aspect of an embodiment is believed at the time of the filing of this patent application to possibly reside broadly in a labeling machine for the positionally accurate application of labels 3 to bottles, cans or similar containers 2 in relation to at least on container-typical design feature 4 having at least one image detection and processing system with at least one camera 15, with which the container-typical design feature 4 of each container 2 moved past this camera on a transport element 8 is detected and which supplies a signal controlling the labeling process, and also having at least one labeling station 9 arranged along the path of motion of the transport element 8, wherein the image detection and processing system 4, 15 detects the orientation and/or the actual form of the container-typical design feature 4 of each container 2 generates from this a signal controlling the instant of transfer of the respective label 3 at the labeling station 9.

Still another feature or aspect of an embodiment is believed at the time of the filing of this patent application to possibly reside broadly in the labeling machine, wherein the instant of transfer or the starting time for the transfer of the respective label 3 to a container is also controlled as a function of the speed of the transport element 8.

A further feature or aspect of an embodiment is believed at the time of the filing of this patent application to possibly reside broadly in the labeling machine, wherein the image detection and processing system for the control of the instant of transfer or start time determines the actual form of the respective container-typical design feature 4, e.g. the distance between at least two reference areas or reference edges of the design feature.

Another feature or aspect of an embodiment is believed at the time of the filing of this patent application to possibly reside broadly in the labeling machine, comprising container carriers 7 arranged on the transport element 8, which carriers can be rotated around the container axis of the containers 2 by control action by means of a drive for the alignment of said containers.

Yet another feature or aspect of an embodiment is believed at the time of the filing of this patent application to possibly reside broadly in the labeling machine, wherein the means for aligning the containers 2 is used for the optical detection of at least one container-typical reference area, for example at least one container-typical reference edge 4.1.

Still another feature or aspect of an embodiment is believed at the time of the filing of this patent application to possibly reside broadly in the labeling machine, comprising an image detection and processing system having at least one camera 13,14 for the alignment of the containers 2.

A further feature or aspect of an embodiment is believed at the time of the filing of this patent application to possibly reside broadly in the labeling machine, comprising the means for the alignment of the containers in at least two chronologically successive steps, first a rough alignment of each container 2 by detection of the respective actual position or orientation of the container-typical design features, by comparing this actual position with a specified or general position or orientation and by rotating the container into the specified or general position, and then a subsequent fine alignment comprising detection of the actual position or orientation of the container-typical design feature, comparison of the actual position or orientation with a specified or general position or orientation and rotation of the container 2 into the specified or general position.

Another feature or aspect of an embodiment is believed at the time of the filing of this patent application to possibly reside broadly in the labeling machine, wherein the means for the rough alignment and the fine alignment each comprises an image detection and processing system having at least one camera 13, 14.

Yet another feature or aspect of an embodiment is believed at the time of the filing of this patent application to possibly reside broadly in the labeling machine, comprising a common computer 12 for the image detection and processing system controlling the instant of transfer and for the image detection and processing system controlling the alignment of the containers 2.

Still another feature or aspect of an embodiment is believed at the time of the filing of this patent application to possibly reside broadly in the labeling machine, comprising a common camera 14 for the image detection and processing system controlling the instant of transfer of the labels and for the image detection and processing system controlling the alignment, e.g. the fine alignment, of the containers 2.

A further feature or aspect of an embodiment is believed at the time of the filing of this patent application to possibly reside broadly in the labeling machine, wherein the at least one labeling station 9 is configured for the use of self-adhesive labels.

One feature or aspect of an embodiment is believed at the time of the filing of this patent application to possibly reside broadly in the labeling machine, wherein it is a rotary labeling machine having a powered rotor 8 rotating around a vertical machine axis and with a plurality of container carriers 7 arranged around the circumference of the rotor.

One feature or aspect of an embodiment is believed at the time of the filing of this patent application to possibly reside broadly in a method of labeling plastic beverage bottles in a beverage bottling plant, said method comprising the steps of: feeding a first filled, closed bottle to a bottle labeling machine; feeding said first filled, closed bottle into a first container carrier on a rotor of said bottle labeling machine; moving said first filled, closed bottle past a first camera; taking at least a first scan of at least a substantial portion of said first filled, closed bottle with said first camera; sending a first signal, relating to said at least one first scan of said first filled, closed bottle, from said first camera to a control unit; detecting a frame raised from the surface of said first filled, closed bottle from said first signal with said control unit; comparing said at least one first scan relating to said frame raised from the surface of said first filled, closed bottle to a stored, at least one electronic image equivalent of at least one bottle in said control unit and determining the orientation of said first filled, closed bottle in said first container carrier of said rotor with respect to said first camera; sending a signal from said control unit to said first container carrier on said rotor of said bottle labeling machine; rotating said first container carrier and thus rotating said first filled, closed bottle into a first predetermined approximate orientation comprising a first, loose tolerance with regards to the position of said frame raised from the surface of said first filled, closed bottle with respect to said first container carrier and preparing said first filled, closed bottle for labeling; moving said first filled, closed bottle past a second camera; taking at least a second scan of at least a substantial portion of said first filled, closed bottle with said second camera; sending a second signal, relating to said at least one second scan of said first filled, closed bottle, from said second camera to said control unit; detecting said frame raised from the surface of said first filled, closed bottle from said second signal with said control unit; comparing said at least one second scan relating to said frame raised from the surface of said first filled, closed bottle, with said control unit, to a stored, at least one electronic image equivalent of at least one bottle and determining the orientation of said first filled, closed bottle in said first container carrier of said rotor; sending a signal from said control unit to said first container carrier on said rotor of said bottle labeling machine; rotating said first container carrier and thus rotating said first filled, closed bottle into a second predetermined orientation comprising a second tolerance, being tighter than said first, loose tolerance, with regards to the position of said frame raised from the surface of said first filled, closed bottle with respect to said first container carrier; correcting said first predetermined approximate orientation, with regards to the position of said frame raised from the surface of said first filled, closed bottle with respect to said first container carrier, with said second predetermined orientation, with regards to the position of said frame raised from the surface of said first filled, closed bottle with respect to said first container carrier, and preparing said first filled, closed bottle for labeling; moving said first filled, closed bottle past a third camera; taking at least one scan of said frame raised from the surface of said first filled, closed bottle with said third camera; sending a third signal, relating to said at least one scan of said frame raised from the surface of said first filled, closed bottle, from said third camera to said control unit; detecting the size and the shape of said frame raised from the surface of said first filled, closed bottle from said third signal with said control unit; measuring the inner dimensions of said frame raised from the surface of said first filled, closed bottle from said third signal with said control unit; comparing said third signal relating to said size and shape of said frame raised from the surface of said first filled, closed bottle, with said control unit, to a stored, at least one electronic image equivalent of a frame raised from the surface of at least one container and determining the inner dimensions of said frame raised from the surface of said first filled, closed bottle in said first container carrier of said rotor; determining the moment of transfer of a first self-adhesive label to said first filled, closed bottle in order to affix said first self-adhesive label on said first filled, closed bottle in a predetermined location and orientation with respect to said frame raised from the surface of said first filled, closed bottle; determining the position of said first self-adhesive label at said moment of transfer of said first self-adhesive label to said first filled, closed bottle, in order to affix said first self-adhesive label on said first filled, closed bottle in a predetermined location and orientation with respect to said frame raised from the surface of said first filled, closed bottle; sending a signal from said control unit to a labeling device adjacent said rotor and initiating the labeling of said first filled, closed bottle; affixing said first self-adhesive label on said first filled, closed bottle in a predetermined location on said first filled, closed bottle and with a predetermined orientation with respect to said frame raised from the surface of said first filled, closed bottle; and moving said first filled, closed bottle out of said first container carrier of said rotor of said labeling machine.

Another feature or aspect of an embodiment is believed at the time of the filing of this patent application to possibly reside broadly in an apparatus configured to perform the method of labeling plastic beverage bottles in a beverage bottling plant, said apparatus comprising: means for feeding a first filled, closed bottle to a bottle labeling machine; means for feeding a first filled, closed bottle into a first container carrier on a rotor of said bottle labeling machine; means for moving a first filled, closed bottle past a first camera; means for taking at least a first scan of at least a substantial portion of a first filled, closed bottle with said first camera; means for sending a first signal, relating to the at least one first scan of a first filled, closed bottle, from said first camera to a control unit; means for detecting a frame raised from the surface of a first filled, closed bottle from the first signal with said control unit; means for comparing the at least one first scan relating to a frame raised from the surface of a first filled, closed bottle to a stored, at least one electronic image equivalent of at least one bottle in said control unit and determining the orientation of a first filled, closed bottle in said first container carrier of said rotor with respect to said first camera; means for sending a signal from said control unit to said first container carrier on said rotor of said bottle labeling machine; means for rotating said first container carrier and thus for rotating a first filled, closed bottle into a first predetermined approximate orientation comprising a first, loose tolerance with regards to the position of a frame raised from the surface of a first filled, closed bottle with respect to said first container carrier and preparing a first filled, closed bottle for labeling; means for moving a first filled, closed bottle past a second camera; means for taking at least a second scan of at least a substantial portion of a first filled, closed bottle with said second camera; means for sending a second signal, relating to the at least one second scan of a first filled, closed bottle, from said second camera to said control unit; means for detecting a frame raised from the surface of a first filled, closed bottle from the second signal with said control unit; means for comparing the at least one second scan relating to a frame raised from the surface of a first filled, closed bottle, with said control unit, to a stored, at least one electronic image equivalent of at least one bottle and determining the orientation of a first filled, closed bottle in said first container carrier of said rotor; means for sending a signal from said control unit to said first container carrier on said rotor of said bottle labeling machine; means for rotating said first container carrier and thus for rotating a first filled, closed bottle into a second predetermined orientation comprising a second tolerance, being tighter than the first, loose tolerance, with regards to the position of a frame raised from the surface of a first filled, closed bottle with respect to said first container carrier; means for correcting the first predetermined approximate orientation, with regards to the position of a frame raised from the surface of a first filled, closed bottle with respect to said first container carrier, with the second predetermined orientation, with regards to the position of a frame raised from the surface of a first filled, closed bottle with respect to said first container carrier, and preparing a first filled, closed bottle for labeling; means for moving a first filled, closed bottle past a third camera; means for taking at least one scan of a frame raised from the surface of a first filled, closed bottle with said third camera; means for sending a third signal, relating to the at least one scan of a frame raised from the surface of a first filled, closed bottle, from said third camera to said control unit; means for detecting the size and the shape of a frame raised from the surface of a first filled, closed bottle from the third signal with said control unit; means for measuring the inner dimensions of a frame raised from the surface of a first filled, closed bottle from the third signal with said control unit; means for comparing the third signal relating to the size and shape of a frame raised from the surface of a first filled, closed bottle, with said control unit, to a stored, at least one electronic image equivalent of a frame raised from the surface of at least one container and determining the inner dimensions of a frame raised from the surface of a first filled, closed bottle in said first container carrier of said rotor; means for determining the moment of transfer of a first self-adhesive label to a first filled, closed bottle in order to affix a first self-adhesive label on a first filled, closed bottle in a predetermined location and orientation with respect to a frame raised from the surface of a first filled, closed bottle; means for determining the position of a first self-adhesive label at a moment of transfer of a first self-adhesive label to a first filled, closed bottle, in order to affix a first self-adhesive label on a first filled, closed bottle in a predetermined location and orientation with respect to a frame raised from the surface of a first filled, closed bottle; means for sending a signal from said control unit to a labeling device adjacent said rotor and initiating the labeling of a first filled, closed bottle; means for affixing a first self-adhesive label on a first filled, closed bottle in a predetermined location on a first filled, closed bottle and with a predetermined orientation with respect to a frame raised from the surface of a first filled, closed bottle; and means for moving a first filled, closed bottle out of said first container carrier of said rotor of said labeling machine.

Yet another feature or aspect of an embodiment is believed at the time of the filing of this patent application to possibly reside broadly in a container labeling arrangement for performing the method, said container labeling arrangement comprising: a first feeding arrangement being configured to feed a first filled, closed bottle to a bottle labeling machine; a second feeding arrangement being configured to feed a first filled, closed bottle into a first container carrier on a rotor of said bottle labeling machine; a first moving arrangement being configured to move a first filled, closed bottle past a first camera; a first scanning arrangement comprising said first camera being configured to take at least a first scan of at least a substantial portion of a first filled, closed bottle; a first sending arrangement being configured to send a first signal, relating to the at least one first scan of a first filled, closed bottle, from said first camera to a control unit; a first detecting arrangement comprising said control unit being configured to detect a frame raised from the surface of a first filled, closed bottle from the first signal; said control unit being further configured to compare the at least one first scan relating to a frame raised from the surface of a first filled, closed bottle to a stored, at least one electronic image equivalent of at least one bottle in said control unit and to determine the orientation of a first filled, closed bottle in said first container carrier of said rotor with respect to said first camera; a second sending arrangement being configured to send a signal from said control unit to said first container carrier on said rotor of said bottle labeling machine; a first rotating arrangement being configured to rotate said first container carrier and thus being further configured to rotate a first filled, closed bottle into a first predetermined approximate orientation comprising a first, loose tolerance with regards to the position of a frame raised from the surface of a first filled, closed bottle with respect to said first container carrier and to prepare a first filled, closed bottle for labeling; a second moving arrangement being configured to move a first filled, closed bottle past a second camera; a second scanning arrangement comprising said second camera being configured to take at least a second scan of at least a substantial portion of a first filled, closed bottle; a third sending arrangement being configured to send a second signal, relating to the at least one second scan of a first filled, closed bottle, from said second camera to said control unit; a second detecting arrangement comprising said control unit being configured to detect a frame raised from the surface of a first filled, closed bottle from the second signal; said control unit being further configured to compare the at least one second scan relating to a frame raised from the surface of a first filled, closed bottle to a stored, at least one electronic image equivalent of at least one bottle and to determine the orientation of a first filled, closed bottle in said first container carrier of said rotor; a fourth sending arrangement being configured to send a signal from said control unit to said first container carrier on said rotor of said bottle labeling machine; a second rotating arrangement being configured to rotate said first container carrier and thus being further configured to rotate a first filled, closed bottle into a second predetermined orientation comprising a second tolerance, being tighter than a first, loose tolerance, with regards to the position of a frame raised from the surface of a first filled, closed bottle with respect to said first container carrier; said second rotating arrangement being further configured to correct the first predetermined approximate orientation, with regards to the position of a frame raised from the surface of a first filled, closed bottle with respect to said first container carrier, with the second predetermined orientation, with regards to the position of a frame raised from the surface of a first filled, closed bottle with respect to said first container carrier, and to prepare a first filled, closed bottle for labeling; a third moving arrangement being configured to move a first filled, closed bottle past a third camera; a third scanning arrangement comprising said third camera being configured to take at least one scan of a frame raised from the surface of a first filled, closed bottle; a fifth sending arrangement being configured to send a third signal, relating to the at least one scan of a frame raised from the surface of a first filled, closed bottle, from said third camera to said control unit; a third detecting arrangement comprising said control unit being configured to detect the size and the shape of a frame raised from the surface of a first filled, closed bottle from the third signal; said control unit being further configured to measure the inner dimensions of a frame raised from the surface of a first filled, closed bottle from the third signal; said control unit being further configured to compare the third signal relating to a size and shape of a frame raised from the surface of a first filled, closed bottle to a stored, at least one electronic image equivalent of a frame raised from the surface of at least one container and to determine the inner dimensions of a frame raised from the surface of a first filled, closed bottle in said first container carrier of said rotor; said control unit being further configured to determine the moment of transfer of a first self-adhesive label to a first filled, closed bottle in order to affix a first self-adhesive label on a first filled, closed bottle in a predetermined location and orientation with respect to a frame raised from the surface of a first filled, closed bottle; said control unit being further configured to determine the position of a first self-adhesive label at a moment of transfer of a first self-adhesive label to a first filled, closed bottle, in order to affix a first self-adhesive label on a first filled, closed bottle in a predetermined location and orientation with respect to a frame raised from the surface of a first filled, closed bottle; a sixth sending arrangement being configured to send a signal from said control unit to a labeling device adjacent said rotor and to initiate the labeling of a first filled, closed bottle; an affixing arrangement being configured to affix a first self-adhesive label on a first filled, closed bottle in a predetermined location on a first filled, closed bottle and with a predetermined orientation with respect to a frame raised from the surface of a first filled, closed bottle; and a fourth moving arrangement being configured to move a first filled, closed bottle out of said first container carrier of said rotor of said labeling machine.

Still another feature or aspect of an embodiment is believed at the time of the filing of this patent application to possibly reside broadly in the method of labeling containers in a container filling plant, wherein: said step of determining said moment of transfer of said label to said container further comprises determining said moment of transfer as a function of the speed of said rotor; said step of detecting the size and/or the shape of said feature of the surface of said container further comprises detecting the size and/or the shape of said feature of the surface of said container with said at least one camera and said control unit in order to determine said moment of transfer; said step of moving a container past said at least one camera further comprises rotating a container on a rotor in a direction of motion past said at least one camera; said method further comprises rotating said container into at least one predetermined orientation with regards to the position of said feature of the surface of said container with respect to said container carrier, prior to said step of moving a container past said at least one camera; said step of rotating said container into at least one predetermined orientation with regards to the position of said feature of the surface of said container with respect to said container carrier further comprises rotating said container around a vertical container axis; said at least one camera comprises at least a first camera and a second camera, and wherein: said method further comprises seating said container into said container carrier on said rotor, prior to said step of moving a container past said at least one camera; rotating said container carrier and said container around the vertical container axis; said step of rotating said container into at least one predetermined orientation with regards to the position of said feature of the surface comprises: optically detecting at least one reference edge of said feature of the surface using said first camera; first roughly aligning said container by detecting, using said first camera, the respective actual position or orientation of said feature of the surface of said container, then comparing this actual position with a predetermined position or orientation, and then rotating the container into the predetermined position; and second finely aligning said container by detecting, using said second camera, the actual position or orientation of said feature of the surface of said container, then comparing the actual position or orientation with a predetermined position or orientation, and then rotating the container into the predetermined position; and controlling the instant of transfer and the image detection and processing system controlling the alignment of the containers using a common computer; said at least one camera comprises a third camera, and wherein: said step of scanning at least once a feature of the surface of said container with said at least one camera comprises scanning at least once a feature of the surface of said container with one of: said second camera and said third camera; said step of affixing the labels comprises affixing self-adhesive labels; and said step of moving said container past said at least one camera comprises rotating a powered rotor of a rotary labeling machine around a vertical machine axis and the plurality of container carriers arranged around the circumference of the rotor.

Another feature or aspect of an embodiment is believed at the time of the filing of this patent application to possibly reside broadly in a method of labeling containers in a container filling plant, said method comprising the steps of: moving a container past at least one camera; scanning at least once a feature of the surface of said container with said at least one camera; sending a signal, relating to said at least one scan of said feature of the surface of said container, from said at least one camera to a control unit; detecting the size and/or the shape of said feature of the surface of said container from said signal with said control unit; comparing said signal relating to said size and/or said shape of said feature of the surface of said container, with said control unit, to a stored, at least one electronic image equivalent of a feature of the surface of at least one container and determining the dimensions of said feature of the surface of said container in said first container carrier of said rotor; determining the moment of transfer of a label to said container and/or the position of said label upon said label being transferred to said container in order to affix said label on said container in a predetermined location and orientation with respect to said feature of the surface of said container; sending a signal from said control unit to a labeling arrangement for the labeling of said container; and affixing said label on said container in a predetermined location on said container and/or with a predetermined orientation with respect to said feature of the surface of said container.

Yet another feature or aspect of an embodiment is believed at the time of the filing of this patent application to possibly reside broadly in a container labeling arrangement for labeling containers in a container filling plant, said container labeling arrangement comprising: a moving arrangement being configured to move a container past at least one camera; a scanning arrangement comprising aid at least one camera being configured to scan at least once a feature of the surface of a container; a first sending arrangement being configured to send a signal, relating to the at least one scan of a feature of the surface of a container, from said at least one camera to a control unit; a detecting arrangement comprising said control unit being configured to detect the size and/or the shape of a feature of the surface of a container from the signal; said control unit being further configured to compare the signal relating to the size and/or the shape of a feature of the surface of a container to a stored, at least one electronic image equivalent of a feature of the surface of at least one container and to determine the dimensions of a feature of the surface of a container in a first container carrier of a rotor; said control unit being further configured to determine the moment of transfer of a label to a container and/or the position of a label upon a label being transferred to a container in order to affix a label on a container in a predetermined location and orientation with respect to a feature of the surface of a container; a second sending arrangement being configured to send a signal from said control unit to a labeling arrangement for the labeling of a container; and an affixing arrangement being configured to affix a label on a container in a predetermined location on a container and/or with a predetermined orientation with respect to a feature of the surface of a container.

Still another feature or aspect of an embodiment is believed at the time of the filing of this patent application to possibly reside broadly in means for performing the method of labeling containers, said means comprising: means for moving a container past at least one camera; means for scanning at least once a feature of a container with said at least one camera; means for sending at least one signal, relating to the at least one scan of a feature of a container, from said at least one camera to at least one control arrangement; means for detecting the size and/or the shape and/or the orientation and/or the location of a feature of a container from the at least one signal with said at least one control arrangement; means for comparing the at least one signal relating to the size and/or the shape and/or the orientation and/or the location of a feature of a container, with said at least one control arrangement, to a stored, at least one electronic image equivalent of a feature of at least one container and determining the dimensions and/or the size and/or the shape and/or the orientation and/or the location of a feature of a container in a container carrier of a rotor; means for determining the moment of transfer of a label to a container and/or the position of said label on a container upon a label being transferred to a container and/or the orientation of a label upon a label being transferred to a container and/or the location of a label upon a label being transferred to a container in order to affix a label on a container in a predetermined location and orientation with respect to a feature of a container; means for sending at least one signal from said at least one control arrangement to a labeling arrangement for the labeling of a container; and means for affixing a label on a container at a predetermined moment and/or in a predetermined location on a container and/or with a predetermined orientation with respect to a feature of a container.

A further feature or aspect of an embodiment is believed at the time of the filing of this patent application to possibly reside broadly in a container labeling arrangement for performing the method, said container labeling arrangement comprising: a moving arrangement being configured to move a container past at least one camera; a scanning arrangement comprising said at least one camera being configured to scan at least once a feature of a container; a first sending arrangement being configured to send at least one signal, relating to the at least one scan of a feature of a container, from said at least one camera to at least one control arrangement; a detecting arrangement comprising said at least one control arrangement being configured to detect the size and/or the shape and/or the orientation and/or the location of a feature of a container from the at least one signal; said at least one control arrangement being further configured to compare the at least one signal relating to the size and/or the shape and/or the orientation and/or the location of a feature of a container to a stored, at least one electronic image equivalent of a feature of at least one container and to determine the dimensions and/or the size and/or the shape and/or the orientation and/or the location of a feature of a container in a container carrier of a rotor; said at least one control arrangement being further configured to determine the moment of transfer of a label to a container and/or the position of a label upon a label being transferred to a container and/or the orientation of a label upon a label being transferred to a container and/or the location of a label upon a label being transferred to a container in order to affix a label on a container in a predetermined location and orientation with respect to a feature of a container; a second sending arrangement being configured to send at least one signal from said at least one control arrangement to a labeling arrangement for the labeling of a container; and an affixing arrangement being configured to affix a label on a container at a predetermined moment and/or in a predetermined location on a container and/or with a predetermined orientation with respect to a feature of a container.

One feature or aspect of an embodiment is believed at the time of the filing of this patent application to possibly reside broadly in the method of labeling containers, wherein said step of determining said moment of transfer of said label to said container further comprises determining said moment of transfer as a function of the speed of said rotor.

Another feature or aspect of an embodiment is believed at the time of the filing of this patent application to possibly reside broadly in the method of labeling containers, wherein said step of detecting the size and/or the shape and/or the orientation and/or the location of said feature of said container further comprises detecting the size and/or the shape and/or the orientation and/or the location of said feature of said container with said at least one camera and said at least one control arrangement in order to determine said moment of transfer.

Yet another feature or aspect of an embodiment is believed at the time of the filing of this patent application to possibly reside broadly in the method of labeling containers, wherein said step of moving a container past said at least one camera further comprises rotating a container on a rotor in a direction of motion past said at least one camera.

Still another feature or aspect of an embodiment is believed at the time of the filing of this patent application to possibly reside broadly in the method of labeling containers, wherein said method further comprises rotating said container into at least one predetermined orientation with regards to the position of said feature of said container with respect to said container carrier, prior to said step of moving a container past said at least one camera.

A further feature or aspect of an embodiment is believed at the time of the filing of this patent application to possibly reside broadly in the method of labeling containers, wherein said step of rotating said container into at least one predetermined orientation with regards to the position of said feature of said container with respect to said container carrier further comprises rotating said container around a vertical container axis.

One feature or aspect of an embodiment is believed at the time of the filing of this patent application to possibly reside broadly in the method of labeling containers, wherein said at least one camera comprises at least a first camera and a second camera, and wherein: said method further comprises seating said container into said container carrier on said rotor, prior to said step of moving a container past said at least one camera; rotating said container carrier and said container around the vertical container axis; said step of rotating said container into at least one predetermined orientation with regards to the position of said feature of said container comprises: optically detecting at least one reference edge of said feature using said first camera; first roughly aligning said container by detecting, using said first camera, the respective actual position or orientation of said feature of said container, then comparing this actual position with a predetermined position or orientation, and then rotating the container into the predetermined position; and second finely aligning said container by detecting, using said second camera, the actual position or orientation of said feature of said container, then comparing the actual position or orientation with a predetermined position or orientation, and then rotating the container into the predetermined position; and controlling the instant of transfer and the image detection and processing system controlling the alignment of the containers using a common computer.

Another feature or aspect of an embodiment is believed at the time of the filing of this patent application to possibly reside broadly in the method of labeling containers, wherein said at least one camera comprises a third camera, and wherein: said step of scanning at least once a feature of said container with said at least one camera comprises scanning at least once a feature of said container with one of: said second camera and said third camera; said step of affixing the labels comprises affixing self-adhesive labels; said step of moving said container past said at least one camera comprises rotating a powered rotor of a rotary labeling machine around a vertical machine axis and the plurality of container carriers arranged around the circumference of the rotor; said method further comprises performing each of the steps in a container filling plant; and said feature of said container comprising a feature on the surface of said container.

Still another feature or aspect of an embodiment is believed at the time of the filing of this patent application to possibly reside broadly in a method of placing an indicum separate from an object on an object, said method comprising the steps of: moving an object past at least one camera; scanning at least once a feature of said object with said at least one camera; sending at least one signal, relating to said at least one scan of said feature of said object, from said at least one camera to at least one control arrangement; detecting the size and/or the shape and/or the orientation and/or the location of said feature of said object from said at least one signal with said at least one control arrangement; comparing said at least one signal relating to said size and/or said shape and/or said orientation and/or said location of said feature of said object, with said at least one control arrangement, to a stored, at least one electronic image equivalent of a feature of at least one object and determining the dimensions and/or said size and/or said shape and/or said orientation and/or said location of said feature of said object in said object carrier of said rotor; determining the moment of transfer of an indicum, separate from the object, to said object and/or the position of said indicum, separate from the object, on said object upon said indicum, separate from the object, being transferred to said object and/or the orientation of said indicum, separate from the object, upon said indicum, separate from the object, being transferred to said object and/or the location of said indicum, separate from the object, upon said indicum, separate from the object, being transferred to said object in order to affix said indicum, separate from the object, on said object in a predetermined location and orientation with respect to said feature of said object; sending at least one signal from said at least one control arrangement to an indicum-placing arrangement for the placing of an indicum, separate from the object, on said object; and placing said indicum, separate from the object, on said object at a predetermined moment and/or in a predetermined location on said object and/or with a predetermined orientation with respect to said feature of said object.

A further feature or aspect of an embodiment is believed at the time of the filing of this patent application to possibly reside broadly in a method of labeling containers, said method comprising the steps of: moving a container past at least one camera; scanning at least once a feature of said container with said at least one camera; sending at least one signal, relating to said at least one scan of said feature of said container, from said at least one camera to at least one control arrangement; detecting the size and/or the shape and/or the orientation and/or the location of said feature of said container from said at least one signal with said at least one control arrangement; comparing said at least one signal relating to said size and/or said shape and/or said orientation and/or said location of said feature of said container, with said at least one control arrangement, to a stored, at least one electronic image equivalent of a feature of at least one container and determining the dimensions and/or said size and/or said shape and/or said orientation and/or said location of said feature of said container in said container carrier of said rotor; determining the moment of transfer of a label to said container and/or the position of said label on said container upon said label being transferred to said container and/or the orientation of said label upon said label being transferred to said container and/or the location of said label upon said label being transferred to said container in order to affix said label on said container in a predetermined location and orientation with respect to said feature of said container; sending at least one signal from said at least one control arrangement to a labeling arrangement for the labeling of said container; and affixing said label on said container at a predetermined moment and/or in a predetermined location on said container and/or with a predetermined orientation with respect to said feature of said container.

Another feature or aspect of an embodiment is believed at the time of the filing of this patent application to possibly reside broadly in a container labeling arrangement for labeling containers, said container labeling arrangement comprising: a moving arrangement being configured to move a container past at least one camera; a scanning arrangement comprising said at least one camera being configured to scan at least once a feature of a container; a first sending arrangement being configured to send at least one signal, relating to the at least one scan of a feature of a container, from said at least one camera to at least one control arrangement; a detecting arrangement comprising said at least one control arrangement being configured to detect the size and/or the shape and/or the orientation and/or the location of a feature of a container from the at least one signal; said at least one control arrangement being further configured to compare the at least one signal relating to the size and/or the shape and/or the orientation and/or the location of a feature of a container to a stored, at least one electronic image equivalent of a feature of at least one container and to determine the dimensions and/or the size and/or the shape and/or the orientation and/or the location of a feature of a container in a container carrier of a rotor; said at least one control arrangement being further configured to determine the moment of transfer of a label to a container and/or the position of a label upon a label being transferred to a container and/or the orientation of a label upon a label being transferred to a container and/or the location of a label upon a label being transferred to a container in order to affix a label on a container in a predetermined location and orientation with respect to a feature of a container; a second sending arrangement being configured to send at least one signal from said at least one control arrangement to a labeling arrangement for the labeling of a container; and an affixing arrangement being configured to affix a label on a container at a predetermined moment and/or in a predetermined location on a container and/or with a predetermined orientation with respect to a feature of a container.

Yet another feature or aspect of an embodiment is believed at the time of the filing of this patent application to possibly reside broadly in the container labeling arrangement, wherein the instant of transfer or the starting time for the transfer of the respective label to a container is also controlled as a function of the speed of the transport element.

Still another feature or aspect of an embodiment is believed at the time of the filing of this patent application to possibly reside broadly in the container labeling arrangement, wherein the image detection and processing system for the control of the instant of transfer or start time determines the actual form of the respective container-typical design feature by determining the distance between at least two reference areas or reference edges of the design feature.

A further feature or aspect of an embodiment is believed at the time of the filing of this patent application to possibly reside broadly in the container labeling arrangement, comprising container carriers arranged on the transport element, which carriers can be rotated around the container axis of the containers by control action by means of a drive for the alignment of said containers.

Another feature or aspect of an embodiment is believed at the time of the filing of this patent application to possibly reside broadly in the container labeling arrangement, wherein the means for aligning the containers is used for the optical detection of at least one container-typical reference edge.

Yet another feature or aspect of an embodiment is believed at the time of the filing of this patent application to possibly reside broadly in the container labeling arrangement, wherein: said labeling machine comprises an image detection and processing system having at least one camera for the alignment of the containers; said labeling machine further comprises the means for the alignment of the containers in at least two chronologically successive steps, first a rough alignment of each container by detection of the respective actual position or orientation of the container-typical design features, by comparing this actual position with a specified position or orientation and by rotating the container into the specified position, and then a subsequent fine alignment comprising detection of the actual position or orientation of the container-typical design feature, comparison of the actual position or orientation with a specified position or orientation and rotation of the container into the specified position; the means for the rough alignment and the fine alignment each comprises an image detection and processing system having at least one camera; said labeling machine further comprises a common computer for the image detection and processing system controlling the instant of transfer and for the image detection and processing system controlling the alignment of the containers; said labeling machine further comprises a common camera for the image detection and processing system controlling the instant of transfer of the labels and for the image detection and processing system controlling the alignment of the containers; the at least one labeling station is configured for the use of self-adhesive labels; said container labeling arrangement comprises a rotary labeling machine having a powered rotor rotating around a vertical machine axis and with a plurality of container carriers arranged around the circumference of the rotor; said container labeling arrangement comprises a component of a container filling plant; and the feature of a container comprises a feature of the surface of a container.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

U.S. patent application Ser. No. 12/355,870, filed on Jan. 19, 2009, having inventor Volker TILL, Attorney Docket No. NHL-HOL-202, and title “METHOD AND APPARATUS FOR THE CIRCUMFERENTIAL LABELING OF A RUN OF BLOW MOLDED BOTTLES WHERE THE INDIVIDUAL BOTTLES IN THE RUN HAVE AT LEAST ONE VARYING DIMENSION DUE TO MANUFACTURING TOLERANCES, THE METHOD AND APPARATUS PROVIDING MORE CONSISTENT LABELING OF INDIVIDUAL CONTAINERS IN THE RUN OF CONTAINERS”, and its corresponding Federal Republic of Germany Patent Application No. 10 2006 038 249.8, filed on Aug. 16, 2006, and International Patent Application No. PCT/EP2007/007190, filed on Aug. 15, 2007, having WIPO Publication No. WO 2008/WO2008019830 and inventor Volker TILL are hereby incorporated by reference as if set forth in their entirety herein.

U.S. patent application Ser. No. 12/370,667, filed on Feb. 13, 2009, having inventor Volker TILL, Attorney Docket No. NHL-HOL-213, and title “METHOD AND APPARATUS FOR THE CIRCUMFERENTIAL PRINTING ONTO INDIVIDUAL BOTTLES IN A RUN OF BOTTLES WHERE THE INDIVIDUAL BOTTLES IN THE RUN HAVE AT LEAST ONE VARYING DIMENSION DUE TO MANUFACTURING TOLERANCES, THE METHOD AND APPARATUS PROVIDING MORE CONSISTENT ARTWORK ON INDIVIDUAL CONTAINERS IN THE RUN OF CONTAINERS”, and its corresponding Federal Republic of Germany Patent Application No. 10 2006 038 247.1, filed on Aug. 16, 2006, and International Patent Application No. PCT/EP2007/7189, filed on Aug. 15, 2007, having WIPO Publication No. WO 2008/01982 and inventor Volker TILL are hereby incorporated by reference as if set forth in their entirety herein.

U.S. Pat. No. 7,331,152, having U.S. patent application Ser. No. 11/551,616, filed on Oct. 20, 2006, having inventor Herbert MENKE, Attorney Docket No. NHL-HOL-148, and title “BEVERAGE BOTTLING PLANT FOR FILLING BEVERAGE BOTTLES HAVING A BEVERAGE BOTTLE ORIENTATION AND POSITIONING ARRANGEMENT,” and its corresponding Federal Republic of Germany Patent Application No. 10 2005 050 902.9, filed on Oct. 21, 2005, are hereby incorporated by reference as if set forth in their entirety herein.

Some examples of cameras or the like optical monitoring apparatus that may possibly be utilized or possibly adapted for use in at least one possible embodiment of the present application may possibly be found in the following U.S. patents: U.S. Pat. No. 5,233,186 issued to Ringlien on Aug. 3, 1993; U.S. Pat. No. 5,243,400 issued to Ringlien on Sep. 7, 1993; U.S. Pat. No. 5,369,713 issued to Schwartz et al. on Nov. 29, 1994; U.S. Pat. No. 5,442,446 issued to Gerber et al. on Aug. 15, 1995; U.S. Pat. No. 5,661,295 issued to Buchmann et al. on Aug. 26, 1997; and U.S. Pat. No. 5,898,169 issued to Nodbryhn on Apr. 27, 1999.

Some examples of rotation sensors that may possibly be utilized or possibly adapted for use in at least one possible embodiment of the present application may possibly be found in the following U.S. patents: U.S. Pat. No. 6,246,232 issued to Okamura on Jun. 12, 2001; U.S. Pat. No. No. 6,448,761 issued to Stumpe on Sep. 10, 2002; U.S. Pat. No. 6,474,162 to Voss et al. on Nov. 5, 2002; U.S. Pat. No. 6,498,481 issued to Apel on Dec. 24, 2002; U.S. Pat. No. 6,532,831 issued to Jin et al. on Mar. 18, 2003; and U.S. Pat. No. 6,672,175 issued to Jin et al. on Jan. 6, 2004.

Some examples of light sensors that may possibly be utilized or possibly adapted for use in at least one possible embodiment of the present application may possibly be found in the following U.S. patents: U.S. Pat. No. 4,899,041 issued to Fetter et al. on Feb. 6, 1990; U.S. Pat. No. 5,225,689 issued to Buckle et al. on Jul. 6, 1993; U.S. Pat. No. 5,365,059 issued to Savage on Nov. 15, 1994; U.S. Pat. No. 5,736,733 issued to Shima et al. on Apr. 7, 1998; U.S. Pat. No. 6,493,567 issued to Krivitski et al. on Dec. 10, 2002; and U.S. Pat. No. 6,566,672 issued to Schlough et al. on May 20, 2003.

Some examples of servo-motors that may possibly be utilized or possibly adapted for use in at least one possible embodiment of the present application may possibly be found in the following U.S. patents: U.S. Pat. No. 4,050,434 issued to Zbikowski et al. on Sep. 27, 1977; U.S. Pat. No. 4,365,538 issued to Andoh on Dec. 28, 1982; U.S. Pat. No. 4,550,626 issued to Brouter on Nov. 5, 1985; U.S. Pat. No. 4,760,699 issued to Jacobsen et al. on Aug. 2, 1988; U.S. Pat. No. 5,076,568 issued to de Jong et al. on Dec. 31, 1991; and U.S. Pat. No. 6,025 issued to Yasui on Feb. 15, 2000.

Some examples of stepping motors that may possibly be utilized or possibly adapted for use in at least one possible embodiment of the present application may possibly be found in the following U.S. patents: U.S. Pat. No. 6,348,774 issued to Andersen et al. on Feb. 19, 2002; U.S. Pat. No. 6,373,209 issued to Gerber et al. on Apr. 16, 2002; U.S. Pat. No. 6,424,061 issued to Fukuda et al. on Jul. 23, 2002; U.S. Pat. No. 6,509,663 issued to Aoun on Jan. 21, 2003; U.S. Pat. No. 6,548,923 to Ohnishi et al. on Apr. 15, 2003; and U.S. Pat. No. 6,661,193 issued to Tsai on Dec. 9, 2003.

Some examples of labeling machines which may possibly be utilized in at least one possible embodiment may possibly be found in the following U.S. patents: U.S. Pat. No. 6,634,400, entitled “Labeling machine;” U.S. Pat. No. 6,561,246, entitled “Labeling machine capable of precise attachment of a label to different sizes of containers;” U.S. Pat. No. 6,550,512, entitled “Labeling machine capable of preventing erroneous attachment of labels on containers;” U.S. Pat. No. 6,543,514, entitled “In-line continuous feed sleeve labeling machine and method;” U.S. Pat. No. 6,378,587, entitled “Cylindrical container labeling machine;” U.S. Pat. No. 6,328,086, entitled “Labeling machine;” U.S. Pat. No. 6,315,021, entitled “Labeling machine;” U.S. Pat. No. 6,263,940, entitled “In-line continuous feed sleeve labeling machine and method;” U.S. Pat. No. 6,199,614, entitled “High speed labeling machine having a constant tension driving system;” U.S. Pat. No. 6,167,935, entitled “Labeling machine; U.S. Pat. No. 6,066,223, entitled “Labeling machine and method; U.S. Pat. No. 6,050,319, entitled “Non-round container labeling machine and method;” and U.S. Pat. No. 6,045,616, entitled “Adhesive station and labeling machine.”

Some examples of position sensors or position sensor systems that may be used or adapted for use in at least one possible embodiment of the present invention may be found in the following U.S. patents: U.S. Pat. No. 5,794,355, issued to inventor Nickum on Aug. 18, 1998; U.S. Pat. No. 5,520,290, issued to inventors Kumar et al. on May 28, 1996; U.S. Pat. No. 5,074,053, issued to inventor West on Dec. 24, 1991; and U.S. Pat. No. 4,087,012, to inventor Fogg on May 2, 1978.

All of the patents, patent applications or patent publications, which were cited in the International Search Report dated Aug. 29, 2007, and/or cited elsewhere are hereby incorporated by reference as if set forth in their entirety herein as follows: DE 20 2005 017180, having the following English translation of the German title “ADJUSTING SYSTEM FOR BOTTLES ON TURNTABLE COMPRISES CAMERAS WHICH DETECT ORIENTATION OF BOTTLES AT DIFFERENT POSITIONS AND CONTROL UNIT WHICH COMPARES DATA OBTAINED WITH DESIRED ORIENTATION AND CONTROLS ADJUSTMENT OF BOTTLES,” published on Jan. 5, 2006; EP 1,628,241, having the title “DEVICE FOR DETECTING STRUCTURES, SUCH AS PROFILES OR STAMPINGS, ON BODIES OF BOTTLES OR SIMILAR DEVICES,” published on Feb. 22, 2006; and DE 202 03 529, having the German title “VORRICHTUNG ZUR STEUERUNG DER DREHBEWEGUNG VON GEFÄSSEN,” published on May 23, 2002.

All of the patents, patent applications or patent publications, which were cited in the German Office Action dated Apr. 17, 2007, and/or cited elsewhere are hereby incorporated by reference as if set forth in their entirety herein as follows: DE 689 07 374, having the following English translation of the German title “LABELING APPARATUS FOR ATTACHING A LABEL ONTO A PREDETERMINED PORTION ON ARTICLES,” published on Oct. 14, 1993; DE 10 2004 040 634, having the following English translation of the German title “BEVERAGE BOTTLING PLANT APPARATUS CONFIGURED LEGAL BEVERAGE BOTTLES IN A BEVERAGE BOTTLING PLANT,” published on Mar. 9, 2006; DE 600 15 376, having the following English translation of the German title “COMPUTER CONTROL POSITION SLAVED SERVO LABELING SYSTEM,” published on May 19, 2005; and DE 20 2005 017 180, having the following English translation of the German title “ADJUSTING SYSTEM FOR BOTTLES ON TURNTABLE COMPRISES CAMERAS WHICH DETECT ORIENTATION OF BOTTLES AT DIFFERENT POSITIONS AND CONTROL UNIT WHICH COMPARES DATA OBTAINED WITH DESIRED ORIENTATION AND CONTROLS ADJUSTMENT OF BOTTLES,” published on Jan. 5, 2006.

The patents, patent applications, and patent publication listed above in the immediately preceding twelve paragraphs, beginning with the phrase “U.S. patent application Ser. No. 12/355,870 . . . ” and ending with the phrase “. . . published on Jan. 5, 2006,” are herein incorporated by reference as if set forth in their entirety. The purpose of incorporating U.S. patents, Foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

The corresponding foreign and international patent publication applications, namely, Federal Republic of Germany Patent Application No. 10 2006 026 618.8, filed on Sep. 2, 2006, having inventor Frank PUTZER, and DE-OS 10 2006 026 618.8 and DE-PS 10 2006 026 618.8, and International Application No. PCT/EP2007/004668, filed on May 25, 2007, having WIPO Publication No. WO 2008/028524 and inventor Frank PUTZER, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

The purpose of incorporating the Foreign equivalent patent application PCT/EP2007/004668 and German Patent Application 10 2006 026 618.8 is solely for the purpose of providing a basis of correction of any wording in the pages of the present application, which may have been mistranslated or misinterpreted by the translator. Words relating to opinions and judgments of the author and not directly relating to the technical details of the description of the embodiments therein are not to be incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned word in this sentence, when not used to describe technical features of one or more embodiments, are not generally considered to be incorporated by reference herein.

Statements made in the original foreign patent applications PCT/EP2007/004668 and DE 10 2006 026 618.8 from which this patent application claims priority which do not have to do with the correction of the translation in this patent application are not to be included in this patent application in the incorporation by reference.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### At Least Partial Nomenclature

| | |
|---|---|
| 1 | Labeling machine |
| 2 | Bottle |
| 3 | Label |
| 3.1 | End of label |
| 4 | Typical geometric feature |
| 5 | Conveyor |
| 6 | Inlet starwheel |
| 7 | Container carrier |
| 8 | Rotor |
| 9 | Labeling station or labeling system |
| 10 | Starwheel |
| 11 | Conveyor |
| 12 | Central controller or central computer |
| 13, 13.1, 13.2 | Camera |
| 14, 15 | Camera |
| A | Direction of rotation of the rotor 8 |
| B | Rotation of the container carriers 7 during alignment of |
| | the bottles 2 |

What is claimed is:

1. A method of labeling plastic beverage bottles in a beverage bottling plant, said method comprising the steps of:
feeding a first filled, closed bottle to a bottle labeling machine;
feeding said first filled, closed bottle into a first container carrier on a rotor of said bottle labeling machine;
moving said first filled, closed bottle past a first camera;
taking at least a first scan of at least a substantial portion of said first filled, closed bottle with said first camera;
sending a first signal, relating to said at least one first scan of said first filled, closed bottle, from said first camera to a control unit;
detecting a frame raised from the surface of said first filled, closed bottle from said first signal with said control unit;
comparing said at least one first scan relating to said frame raised from the surface of said first filled, closed bottle to a stored, at least one electronic image equivalent of at least one bottle in said control unit and determining the orientation of said first filled, closed bottle in said first container carrier of said rotor with respect to said first camera;
sending a signal from said control unit to said first container carrier on said rotor of said bottle labeling machine;
rotating said first container carrier and thus rotating said first filled, closed bottle into a first predetermined approximate orientation comprising a first, loose tolerance with regards to the position of said frame raised from the surface of said first filled, closed bottle with respect to said first container carrier and preparing said first filled, closed bottle for labeling;
moving said first filled, closed bottle past a second camera;
taking at least a second scan of at least a substantial portion of said first filled, closed bottle with said second camera;
sending a second signal, relating to said at least one second scan of said first filled, closed bottle, from said second camera to said control unit;
detecting said frame raised from the surface of said first filled, closed bottle from said second signal with said control unit;
comparing said at least one second scan relating to said frame raised from the surface of said first filled, closed bottle, with said control unit, to a stored, at least one electronic image equivalent of at least one bottle and determining the orientation of said first filled, closed bottle in said first container carrier of said rotor;
sending a signal from said control unit to said first container carrier on said rotor of said bottle labeling machine;
rotating said first container carrier and thus rotating said first filled, closed bottle into a second predetermined orientation comprising a second tolerance, being tighter than said first, loose tolerance, with regards to the position of said frame raised from the surface of said first filled, closed bottle with respect to said first container carrier;
correcting said first predetermined approximate orientation, with regards to the position of said frame raised from the surface of said first filled, closed bottle with respect to said first container carrier, with said second predetermined orientation, with regards to the position of said frame raised from the surface of said first filled, closed bottle with respect to said first container carrier, and preparing said first filled, closed bottle for labeling;
moving said first filled, closed bottle past a third camera;
taking at least one scan of said frame raised from the surface of said first filled, closed bottle with said third camera;
sending a third signal, relating to said at least one scan of said frame raised from the surface of said first filled, closed bottle, from said third camera to said control unit;
detecting the size and the shape of said frame raised from the surface of said first filled, closed bottle from said third signal with said control unit;
measuring the inner dimensions of said frame raised from the surface of said first filled, closed bottle from said third signal with said control unit;
comparing said third signal relating to said size and shape of said frame raised from the surface of said first filled, closed bottle, with said control unit, to a stored, at least one electronic image equivalent of a frame raised from the surface of at least one container and determining the inner dimensions of said frame raised from the surface of said first filled, closed bottle in said first container carrier of said rotor;
determining the moment of transfer of a first self-adhesive label to said first filled, closed bottle in order to affix said first self-adhesive label on said first filled, closed bottle in a predetermined location and orientation with respect to said frame raised from the surface of said first filled, closed bottle;
determining the position of said first self-adhesive label at said moment of transfer of said first self-adhesive label to said first filled, closed bottle, in order to affix said first self-adhesive label on said first filled, closed bottle in a predetermined location and orientation with respect to said frame raised from the surface of said first filled, closed bottle;
sending a signal from said control unit to a labeling device adjacent said rotor and initiating the labeling of said first filled, closed bottle;
affixing said first self-adhesive label on said first filled, closed bottle in a predetermined location on said first filled, closed bottle and with a predetermined orientation with respect to said frame raised from the surface of said first filled, closed bottle; and
moving said first filled, closed bottle out of said first container carrier of said rotor of said labeling machine.

2. Apparatus configured to perform the method of labeling plastic beverage bottles in a beverage bottling plant according to claim 1, said apparatus comprising:
means for feeding a first filled, closed bottle to a bottle labeling machine;
means for feeding a first filled, closed bottle into a first container carrier on a rotor of said bottle labeling machine;
means for moving a first filled, closed bottle past a first camera;
means for taking at least a first scan of at least a substantial portion of a first filled, closed bottle with said first camera;
means for sending a first signal, relating to the at least one first scan of a first filled, closed bottle, from said first camera to a control unit;
means for detecting a frame raised from the surface of a first filled, closed bottle from the first signal with said control unit;
means for comparing the at least one first scan relating to a frame raised from the surface of a first filled, closed bottle to a stored, at least one electronic image equivalent of at least one bottle in said control unit and determining the orientation of a first filled, closed bottle in said first container carrier of said rotor with respect to said first camera;
means for sending a signal from said control unit to said first container carrier on said rotor of said bottle labeling machine;
means for rotating said first container carrier and thus for rotating a first filled, closed bottle into a first predetermined approximate orientation comprising a first, loose tolerance with regards to the position of a frame raised from the surface of a first filled, closed bottle with respect to said first container carrier and preparing a first filled, closed bottle for labeling;
means for moving a first filled, closed bottle past a second camera;
means for taking at least a second scan of at least a substantial portion of a first filled, closed bottle with said second camera;
means for sending a second signal, relating to the at least one second scan of a first filled, closed bottle, from said second camera to said control unit;
means for detecting a frame raised from the surface of a first filled, closed bottle from the second signal with said control unit;
means for comparing the at least one second scan relating to a frame raised from the surface of a first filled, closed bottle, with said control unit, to a stored, at least one electronic image equivalent of at least one bottle and determining the orientation of a first filled, closed bottle in said first container carrier of said rotor;
means for sending a signal from said control unit to said first container carrier on said rotor of said bottle labeling machine;
means for rotating said first container carrier and thus for rotating a first filled, closed bottle into a second predetermined orientation comprising a second tolerance, being tighter than the first, loose tolerance, with regards to the position of a frame raised from the surface of a first filled, closed bottle with respect to said first container carrier;
means for correcting the first predetermined approximate orientation, with regards to the position of a frame raised from the surface of a first filled, closed bottle with respect to said first container carrier, with the second predetermined orientation, with regards to the position of a frame raised from the surface of a first filled, closed bottle with respect to said first container carrier, and preparing a first filled, closed bottle for labeling;
means for moving a first filled, closed bottle past a third camera;
means for taking at least one scan of a frame raised from the surface of a first filled, closed bottle with said third camera;
means for sending a third signal, relating to the at least one scan of a frame raised from the surface of a first filled, closed bottle, from said third camera to said control unit;
means for detecting the size and the shape of a frame raised from the surface of a first filled, closed bottle from the third signal with said control unit;
means for measuring the inner dimensions of a frame raised from the surface of a first filled, closed bottle from the third signal with said control unit;
means for comparing the third signal relating to the size and shape of a frame raised from the surface of a first filled, closed bottle, with said control unit, to a stored, at least one electronic image equivalent of a frame raised from the surface of at least one container and determining the inner dimensions of a frame raised from the surface of a first filled, closed bottle in said first container carrier of said rotor;
means for determining the moment of transfer of a first self-adhesive label to a first filled, closed bottle in order to affix a first self-adhesive label on a first filled, closed bottle in a predetermined location and orientation with respect to a frame raised from the surface of a first filled, closed bottle;
means for determining the position of a first self-adhesive label at a moment of transfer of a first self-adhesive label to a first filled, closed bottle, in order to affix a first self-adhesive label on a first filled, closed bottle in a predetermined location and orientation with respect to a frame raised from the surface of a first filled, closed bottle;
means for sending a signal from said control unit to a labeling device adjacent said rotor and initiating the labeling of a first filled, closed bottle;
means for affixing a first self-adhesive label on a first filled, closed bottle in a predetermined location on a first filled, closed bottle and with a predetermined orientation with respect to a frame raised from the surface of a first filled, closed bottle; and
means for moving a first filled, closed bottle out of said first container carrier of said rotor of said labeling machine.

3. A container labeling arrangement for performing the method according to claim 1, said container labeling arrangement comprising:
a first feeding arrangement being configured to feed a first filled, closed bottle to a bottle labeling machine;
a second feeding arrangement being configured to feed a first filled, closed bottle into a first container carrier on a rotor of said bottle labeling machine;
a first moving arrangement being configured to move a first filled, closed bottle past a first camera;
a first scanning arrangement comprising said first camera being configured to take at least a first scan of at least a substantial portion of a first filled, closed bottle;
a first sending arrangement being configured to send a first signal, relating to the at least one first scan of a first filled, closed bottle, from said first camera to a control unit;
a first detecting arrangement comprising said control unit being configured to detect a frame raised from the surface of a first filled, closed bottle from the first signal;
said control unit being further configured to compare the at least one first scan relating to a frame raised from the surface of a first filled, closed bottle to a stored, at least one electronic image equivalent of at least one bottle in said control unit and to determine the orientation of a first filled, closed bottle in said first container carrier of said rotor with respect to said first camera;
a second sending arrangement being configured to send a signal from said control unit to said first container carrier on said rotor of said bottle labeling machine;
a first rotating arrangement being configured to rotate said first container carrier and thus being further configured to rotate a first filled, closed bottle into a first predetermined approximate orientation comprising a first, loose tolerance with regards to the position of a frame raised from the surface of a first filled, closed bottle with respect to said first container carrier and to prepare a first filled, closed bottle for labeling;
a second moving arrangement being configured to move a first filled, closed bottle past a second camera;
a second scanning arrangement comprising said second camera being configured to take at least a second scan of at least a substantial portion of a first filled, closed bottle;
a third sending arrangement being configured to send a second signal, relating to the at least one second scan of a first filled, closed bottle, from said second camera to said control unit;
a second detecting arrangement comprising said control unit being configured to detect a frame raised from the surface of a first filled, closed bottle from the second signal;
said control unit being further configured to compare the at least one second scan relating to a frame raised from the surface of a first filled, closed bottle to a stored, at least one electronic image equivalent of at least one bottle and to determine the orientation of a first filled, closed bottle in said first container carrier of said rotor;
a fourth sending arrangement being configured to send a signal from said control unit to said first container carrier on said rotor of said bottle labeling machine;
a second rotating arrangement being configured to rotate said first container carrier and thus being further configured to rotate a first filled, closed bottle into a second predetermined orientation comprising a second tolerance, being tighter than a first, loose tolerance, with regards to the position of a frame raised from the surface of a first filled, closed bottle with respect to said first container carrier;
said second rotating arrangement being further configured to correct the first predetermined approximate orientation, with regards to the position of a frame raised from the surface of a first filled, closed bottle with respect to said first container carrier, with the second predetermined orientation, with regards to the position of a frame raised from the surface of a first filled, closed bottle with respect to said first container carrier, and to prepare a first filled, closed bottle for labeling;
a third moving arrangement being configured to move a first filled, closed bottle past a third camera;
a third scanning arrangement comprising said third camera being configured to take at least one scan of a frame raised from the surface of a first filled, closed bottle;
a fifth sending arrangement being configured to send a third signal, relating to the at least one scan of a frame raised from the surface of a first filled, closed bottle, from said third camera to said control unit;
a third detecting arrangement comprising said control unit being configured to detect the size and the shape of a frame raised from the surface of a first filled, closed bottle from the third signal;
said control unit being further configured to measure the inner dimensions of a frame raised from the surface of a first filled, closed bottle from the third signal;
said control unit being further configured to compare the third signal relating to a size and shape of a frame raised from the surface of a first filled, closed bottle to a stored, at least one electronic image equivalent of a frame raised from the surface of at least one container and to determine the inner dimensions of a frame raised from the surface of a first filled, closed bottle in said first container carrier of said rotor;
said control unit being further configured to determine the moment of transfer of a first self-adhesive label to a first filled, closed bottle in order to affix a first self-adhesive label on a first filled, closed bottle in a predetermined location and orientation with respect to a frame raised from the surface of a first filled, closed bottle;
said control unit being further configured to determine the position of a first self-adhesive label at a moment of transfer of a first self-adhesive label to a first filled, closed bottle, in order to affix a first self-adhesive label on a first filled, closed bottle in a predetermined location and orientation with respect to a frame raised from the surface of a first filled, closed bottle;
a sixth sending arrangement being configured to send a signal from said control unit to a labeling device adjacent said rotor and to initiate the labeling of a first filled, closed bottle;
an affixing arrangement being configured to affix a first self-adhesive label on a first filled, closed bottle in a predetermined location on a first filled, closed bottle and with a predetermined orientation with respect to a frame raised from the surface of a first filled, closed bottle; and
a fourth moving arrangement being configured to move a first filled, closed bottle out of said first container carrier of said rotor of said labeling machine.

4. The method of labeling containers in a container filling plant according to claim 1, wherein:
said step of determining said moment of transfer of said label to said container further comprises determining said moment of transfer as a function of the speed of said rotor;
said step of detecting the size and/or the shape of said feature of the surface of said container further comprises detecting the size and/or the shape of said feature of the surface of said container with said at least one camera and said control unit in order to determine said moment of transfer;
said step of moving a container past said at least one camera further comprises rotating a container on a rotor in a direction of motion past said at least one camera;
said method further comprises rotating said container into at least one predetermined orientation with regards to the position of said feature of the surface of said container with respect to said container carrier, prior to said step of moving a container past said at least one camera;
said step of rotating said container into at least one predetermined orientation with regards to the position of said feature of the surface of said container with respect to said container carrier further comprises rotating said container around a vertical container axis;
said at least one camera comprises at least a first camera and a second camera, and wherein:
said method further comprises seating said container into said container carrier on said rotor, prior to said step of moving a container past said at least one camera;
rotating said container carrier and said container around the vertical container axis;
said step of rotating said container into at least one predetermined orientation with regards to the position of said feature of the surface comprises:
optically detecting at least one reference edge of said feature of the surface using said first camera;
first roughly aligning said container by detecting, using said first camera, the respective actual position or orientation of said feature of the surface of said container, then comparing this actual position with a predetermined position or orientation, and then rotating the container into the predetermined position; and
second finely aligning said container by detecting, using said second camera, the actual position or orientation of said feature of the surface of said container, then comparing the actual position or orientation with a predetermined position or orientation, and then rotating the container into the predetermined position; and
controlling the instant of transfer and the image detection and processing system controlling the alignment of the containers using a common computer.
said at least one camera comprises a third camera, and wherein:
said step of scanning at least once a feature of the surface of said container with said at least one camera comprises scanning at least once a feature of the surface of said container with one of: said second camera and said third camera;
said step of affixing the labels comprises affixing self-adhesive labels; and
said step of moving said container past said at least one camera comprises rotating a powered rotor of a rotary labeling machine around a vertical machine axis and the plurality of container carriers arranged around the circumference of the rotor.

5. A method of labeling containers, said method comprising the steps of:
moving a container past at least one camera;
scanning at least once a feature of said container with said at least one camera;
sending at least one signal, relating to said at least one scan of said feature of said container, from said at least one camera to at least one control arrangement;
detecting the size and/or the shape and/or the orientation and/or the location of said feature of said container from said at least one signal with said at least one control arrangement;
comparing said at least one signal relating to said size and/or said shape and/or said orientation and/or said location of said feature of said container, with said at least one control arrangement, to a stored, at least one electronic image equivalent of a feature of at least one container and determining the dimensions and/or said size and/or said shape and/or said orientation and/or said location of said feature of said container in said container carrier of said rotor;
determining the moment of transfer of a label to said container and/or the position of said label on said container upon said label being transferred to said container and/or the orientation of said label upon said label being transferred to said container and/or the location of said label upon said label being transferred to said container in order to affix said label on said container in a predetermined location and orientation with respect to said feature of said container;
sending at least one signal from said at least one control arrangement to a labeling arrangement for the labeling of said container; and
affixing said label on said container at a predetermined moment and/or in a predetermined location on said container and/or with a predetermined orientation with respect to said feature of said container.

6. Means for performing the method of labeling containers according to claim 5, said means comprising:
means for moving a container past at least one camera;
means for scanning at least once a feature of a container with said at least one camera;
means for sending at least one signal, relating to the at least one scan of a feature of a container, from said at least one camera to at least one control arrangement;
means for detecting the size and/or the shape and/or the orientation and/or the location of a feature of a container from the at least one signal with said at least one control arrangement;
means for comparing the at least one signal relating to the size and/or the shape and/or the orientation and/or the location of a feature of a container, with said at least one control arrangement, to a stored, at least one electronic image equivalent of a feature of at least one container and determining the dimensions and/or the size and/or the shape and/or the orientation and/or the location of a feature of a container in a container carrier of a rotor;
means for determining the moment of transfer of a label to a container and/or the position of said label on a container upon a label being transferred to a container and/or the orientation of a label upon a label being transferred to a container and/or the location of a label upon a label being transferred to a container in order to affix a label on a container in a predetermined location and orientation with respect to a feature of a container;
means for sending at least one signal from said at least one control arrangement to a labeling arrangement for the labeling of a container; and
means for affixing a label on a container at a predetermined moment and/or in a predetermined location on a container and/or with a predetermined orientation with respect to a feature of a container.

7. A container labeling arrangement for performing the method of claim 5, said container labeling arrangement comprising:
a moving arrangement being configured to move a container past at least one camera;
a scanning arrangement comprising said at least one camera being configured to scan at least once a feature of a container;
a first sending arrangement being configured to send at least one signal, relating to the at least one scan of a feature of a container, from said at least one camera to at least one control arrangement;
a detecting arrangement comprising said at least one control arrangement being configured to detect the size and/or the shape and/or the orientation and/or the location of a feature of a container from the at least one signal;
said at least one control arrangement being further configured to compare the at least one signal relating to the size and/or the shape and/or the orientation and/or the location of a feature of a container to a stored, at least one electronic image equivalent of a feature of at least one container and to determine the dimensions and/or the size and/or the shape and/or the orientation and/or the location of a feature of a container in a container carrier of a rotor;
said at least one control arrangement being further configured to determine the moment of transfer of a label to a container and/or the position of a label upon a label being transferred to a container and/or the orientation of a label upon a label being transferred to a container and/or the location of a label upon a label being transferred to a container in order to affix a label on a container in a predetermined location and orientation with respect to a feature of a container;
a second sending arrangement being configured to send at least one signal from said at least one control arrangement to a labeling arrangement for the labeling of a container; and
an affixing arrangement being configured to affix a label on a container at a predetermined moment and/or in a predetermined location on a container and/or with a predetermined orientation with respect to a feature of a container.

8. The method of labeling containers according to claim 5, wherein said step of determining said moment of transfer of said label to said container further comprises determining said moment of transfer as a function of the speed of said rotor.

9. The method of labeling containers according to claim 8, wherein said step of detecting the size and/or the shape and/or the orientation and/or the location of said feature of said container further comprises detecting the size and/or the shape and/or the orientation and/or the location of said feature of said container with said at least one camera and said at least one control arrangement in order to determine said moment of transfer.

10. The method of labeling containers according to claim 9, wherein said step of moving a container past said at least one camera further comprises rotating a container on a rotor in a direction of motion past said at least one camera.

11. The method of labeling containers according to claim 10, wherein said method further comprises rotating said container into at least one predetermined orientation with regards to the position of said feature of said container with respect to said container carrier, prior to said step of moving a container past said at least one camera.

12. The method of labeling containers according to claim 11, wherein said step of rotating said container into at least one predetermined orientation with regards to the position of said feature of said container with respect to said container carrier further comprises rotating said container around a vertical container axis.

13. The method of labeling containers according to claim 12, wherein said at least one camera comprises at least a first camera and a second camera, and wherein:
said method further comprises seating said container into said container carrier on said rotor, prior to said step of moving a container past said at least one camera;
rotating said container carrier and said container around the vertical container axis;
said step of rotating said container into at least one predetermined orientation with regards to the position of said feature of said container comprises:
optically detecting at least one reference edge of said feature using said first camera;
first roughly aligning said container by detecting, using said first camera, the respective actual position or orientation of said feature of said container, then comparing this actual position with a predetermined position or orientation, and then rotating the container into the predetermined position; and
second finely aligning said container by detecting, using said second camera, the actual position or orientation of said feature of said container, then comparing the actual position or orientation with a predetermined position or orientation, and then rotating the container into the predetermined position; and
controlling the instant of transfer and the image detection and processing system controlling the alignment of the containers using a common computer.

14. The method of labeling containers according to claim 13, wherein said at least one camera comprises a third camera, and wherein:
said step of scanning at least once a feature of said container with said at least one camera comprises scanning at least once a feature of said container with one of: said second camera and said third camera;
said step of affixing the labels comprises affixing self-adhesive labels;
said step of moving said container past said at least one camera comprises rotating a powered rotor of a rotary labeling machine around a vertical machine axis and the plurality of container carriers arranged around the circumference of the rotor;
said method further comprises performing each of the steps in a container filling plant; and
said feature of said container comprises a feature of the surface of said container.

15. A container labeling arrangement for labeling containers, said container labeling arrangement comprising:
a moving arrangement being configured to move a container past at least one camera;
a scanning arrangement comprising said at least one camera being configured to scan at least once a feature of a container;
a first sending arrangement being configured to send at least one signal, relating to the at least one scan of a feature of a container, from said at least one camera to at least one control arrangement;
a detecting arrangement comprising said at least one control arrangement being configured to detect the size and/or the shape and/or the orientation and/or the location of a feature of a container from the at least one signal;
said at least one control arrangement being further configured to compare the at least one signal relating to the size and/or the shape and/or the orientation and/or the location of a feature of a container to a stored, at least one electronic image equivalent of a feature of at least one container and to determine the dimensions and/or the size and/or the shape and/or the orientation and/or the location of a feature of a container in a container carrier of a rotor;
said at least one control arrangement being further configured to determine the moment of transfer of a label to a container and/or the position of a label upon a label being transferred to a container and/or the orientation of a label upon a label being transferred to a container and/or the location of a label upon a label being transferred to a container in order to affix a label on a container in a predetermined location and orientation with respect to a feature of a container;
a second sending arrangement being configured to send at least one signal from said at least one control arrangement to a labeling arrangement for the labeling of a container; and
an affixing arrangement being configured to affix a label on a container at a predetermined moment and/or in a predetermined location on a container and/or with a predetermined orientation with respect to a feature of a container.

16. The container labeling arrangement according to claim 15, wherein the instant of transfer or the starting time for the transfer of the respective label to a container is also controlled as a function of the speed of the transport element.

17. The container labeling arrangement according to claim 16, wherein the image detection and processing system for the control of the instant of transfer or start time determines the actual form of the respective container-typical design feature by determining the distance between at least two reference areas or reference edges of the design feature.

18. The container labeling arrangement according to claim 17, comprising container carriers arranged on the transport element, which carriers can be rotated around the container axis of the containers by control action by means of a drive for the alignment of said containers.

19. The container labeling arrangement according to claim 18, wherein the means for aligning the containers is used for the optical detection of at least one container-typical reference edge.

20. The container labeling arrangement according to claim 19, wherein:
said labeling machine comprises an image detection and processing system having at least one camera for the alignment of the containers;
said labeling machine further comprises the means for the alignment of the containers in at least two chronologically successive steps, first a rough alignment of each container by detection of the respective actual position or orientation of the container-typical design features, by comparing this actual position with a specified position or orientation and by rotating the container into the specified position, and then a subsequent fine alignment comprising detection of the actual position or orientation of the container-typical design feature, comparison of the actual position or orientation with a specified position or orientation and rotation of the container into the specified position;
the means for the rough alignment and the fine alignment each comprises an image detection and processing system having at least one camera;
said labeling machine further comprises a common computer for the image detection and processing system controlling the instant of transfer and for the image detection and processing system controlling the alignment of the containers;
said labeling machine further comprises a common camera for the image detection and processing system controlling the instant of transfer of the labels and for the image detection and processing system controlling the alignment of the containers;
the at least one labeling station is configured for the use of self-adhesive labels;
said container labeling arrangement comprises a rotary labeling machine having a powered rotor rotating around a vertical machine axis and with a plurality of container carriers arranged around the circumference of the rotor;
said container labeling arrangement comprises a component in a container filling plant;
and the feature of a container comprises a feature of the surface of a container.
